(19) United States
(12) Patent Application Publication
(10) Pub. No.: US 2026/0367482 A1
(43) Pub. Date: Nov. 19, 2026

(54) IMAGING LENS ASSEMBLY MODULE, CAMERA MODULE AND ELECTRONIC DEVICE

(71) Applicant: LARGAN PRECISION CO., LTD., Taichung City (TW)

(72) Inventors: Ming-Yi YAO, Taichung City (TW); Shen Wu HSIAO, Taichung City (TW); Chen-Wei FAN, Taichung City (TW)

(21) Appl. No.: 19/657,098

(22) Filed: Apr. 24, 2026

(30) Foreign Application Priority Data
May 9, 2025 (TW) 114117569

(51) Int. Cl. G03B 9/06; G02B 13/00; G03B 30/00

(52) U.S. Cl. CPC G03B 9/06; G02B 13/001; G03B 30/00

(57) ABSTRACT

An imaging lens assembly module includes a lens assembly and an opaque optical element. The opaque optical element is disposed along the central axis of the lens assembly, and includes a central opening, a light blocking portion and a plurality of spiral structures. The central opening is disposed around the central axis. The light blocking portion extends from the central opening to a direction away from the central axis, and faces towards an object side or an image side of the lens assembly. The spiral structures are disposed on the light blocking portion, and are arranged around the central axis. Each spiral structure includes an adaxial end close to the central axis and an abaxial end away from the central axis, and each spiral structure extends spirally from the adaxial end to the abaxial end by surrounding the central axis towards a direction away from the central axis.

### RELATED APPLICATIONS

This application claims priority to Taiwan Application Serial Number 114117569, filed May 9, 2025, which is herein incorporated by reference.

### BACKGROUND

### Technical Field

The present disclosure relates to an imaging lens assembly module and a camera module. More particularly, the present disclosure relates to an imaging lens assembly module and a camera module applicable to portable electronic devices.

### Description of Related Art

In recent years, portable electronic devices have developed rapidly. For example, intelligent electronic devices and tablets have been filled in the lives of modern people, and imaging lens assembly modules mounted on portable electronic devices have also prospered. However, as technology advances, the image quality requirements of the imaging lens assembly module are becoming higher and higher. Therefore, an imaging lens assembly module, which can enhance the image quality, needs to be developed.

### SUMMARY

According to one aspect of the present disclosure, an imaging lens assembly module includes a lens assembly and an opaque optical element. The lens assembly has a central axis. The opaque optical element is disposed along the central axis with the lens assembly, and includes a central opening, a light blocking portion and a plurality of spiral structures. The central opening is disposed around the central axis. The light blocking portion extends from the central opening to a direction away from the central axis, and faces towards an object side or an image side of the lens assembly. The spiral structures are disposed on the light blocking portion, and are arranged around the central axis. Each of the spiral structures includes an adaxial end close to the central axis and an abaxial end away from the central axis, and each of the spiral structures extends spirally from the adaxial end to the abaxial end by surrounding the central axis towards a direction away from the central axis.

According to one aspect of the present disclosure, a camera module includes the imaging lens assembly module of the aforementioned aspect of the present disclosure.

According to one aspect of the present disclosure, an electronic device includes the camera module of the aforementioned aspect of the present disclosure.

According to one aspect of the present disclosure, an imaging lens assembly module includes a lens assembly and a lens barrel. The lens assembly has a central axis. The lens barrel has an internal space for containing the lens assembly, and is disposed along the central axis with the lens assembly. The lens barrel includes a central opening, a light blocking portion and a plurality of spiral structures. The central opening is disposed around the central axis. The light blocking portion extends from the central opening to a direction away from the central axis, and faces towards an object side of the lens assembly. The spiral structures are disposed on the light blocking portion, and are arranged around the central axis regularly, wherein the spiral structures and the lens barrel are formed integrally. Each of the spiral structures includes an adaxial end close to the central axis and an abaxial end away from the central axis, and each of the spiral structures extends spirally from the adaxial end to the abaxial end by surrounding the central axis towards a direction away from the central axis.

According to one aspect of the present disclosure, a camera module includes the imaging lens assembly module of the aforementioned aspect of the present disclosure.

According to one aspect of the present disclosure, an electronic device includes the camera module of the aforementioned aspect of the present disclosure.

### BRIEF DESCRIPTION OF THE DRAWINGS

The present disclosure can be more fully understood by reading the following detailed description of the embodiment, with reference made to the accompanying drawings as follows:

FIG. 1A is a three-dimensional view of an imaging lens assembly module of the 1st example according to the 1st embodiment of the present disclosure.

FIG. 1B is a front view of an opaque optical element of FIG. 1A.

FIG. 1C is a plane view of the imaging lens assembly module of FIG. 1A.

FIG. 1D is a plane view of the spiral structures of FIG. 1A.

FIG. 1E is a three-dimensional view of the spiral structures of FIG. 1A.

FIG. 1F is a three-dimensional view of an imaging lens assembly module 100 of the 2nd example according to the 1st embodiment of the present disclosure.

FIG. 1G is a front view of an opaque optical element of FIG. 1F.

FIG. 1H is a schematic view of concave-convex structures of the 3rd example according to the 1st embodiment of the present disclosure.

FIG. 1I is a schematic view of concave-convex structures of the 4th example according to the 1st embodiment of the present disclosure.

FIG. 2A is a three-dimensional view of an imaging lens assembly module of the 1st example according to the 2nd embodiment of the present disclosure.

FIG. 2B is a front view of an opaque optical element of FIG. 2A.

FIG. 2C is a plane view of the imaging lens assembly module of FIG. 2A.

FIG. 2D is a three-dimensional view of an imaging lens assembly module of the 2nd example according to the 2nd embodiment of the present disclosure.

FIG. 2E is a front view of an opaque optical element of FIG. 2D.

FIG. 2F is a plane view of the imaging lens assembly module of FIG. 2D.

FIG. 2G is a three-dimensional view of an imaging lens assembly module of the 3rd example according to the 2nd embodiment of the present disclosure.

FIG. 2H is a front view of an opaque optical element of FIG. 2G.

FIG. 2I is a plane view of the imaging lens assembly module of FIG. 2G.

FIG. 2J is a three-dimensional view of an imaging lens assembly module of the 4th example according to the 2nd embodiment of the present disclosure.

FIG. 2K is a front view of an opaque optical element of FIG. 2J.

FIG. 2L is a plane view of the imaging lens assembly module of FIG. 2J.

FIG. 2M is a three-dimensional view of an imaging lens assembly module of the 5th example according to the 2nd embodiment of the present disclosure.

FIG. 2N is a front view of an opaque optical element of FIG. 2M.

FIG. 2O is a plane view of the imaging lens assembly module of FIG. 2M.

FIG. 3A is a three-dimensional view of an imaging lens assembly module of the 1st example according to the 3rd embodiment of the present disclosure.

FIG. 3B is a plane view of the imaging lens assembly module of FIG. 3A.

FIG. 3C is a front view of the opaque optical element of FIG. 3A.

FIG. 3D is an enlarged view of the spiral structures in FIG. 3C.

FIG. 3E is a three-dimensional view of an imaging lens assembly module of the 2nd example according to the 3rd embodiment of the present disclosure.

FIG. 3F is a plane view of the imaging lens assembly module of FIG. 3E.

FIG. 3G is a front view of the opaque optical element of FIG. 3E.

FIG. 3H is an enlarged view of the spiral structures in FIG. 3G.

FIG. 4A is a schematic view of an electronic device according to the 4th embodiment of the present disclosure.

FIG. 4B is another schematic view of the electronic device according to the 4th embodiment of FIG. 4A.

FIG. 4C is a schematic view of an image captured via the electronic device according to the 4th embodiment of FIG. 4A.

FIG. 4D is another schematic view of the image captured via the electronic device according to the 4th embodiment of FIG. 4A.

FIG. 4E is the other schematic view of the image captured via the electronic device according to the 4th embodiment of FIG. 4A.

FIG. 5 is a schematic view of an electronic device according to the 5th embodiment of the present disclosure.

FIG. 6A is a schematic view of a vehicle instrument according to the 6th embodiment of the present disclosure.

FIG. 6B is another schematic view of the vehicle instrument according to the 6th embodiment in FIG. 6A.

FIG. 6C is another schematic view of the vehicle instrument according to the 6th embodiment in FIG. 6A.

### DETAILED DESCRIPTION

The present disclosure provides an imaging lens assembly module, which includes a lens assembly and an opaque optical element. The lens assembly has a central axis. The opaque optical element is disposed along the central axis with the lens assembly, which includes a central opening, a light blocking portion and a plurality of spiral structures. The central opening is disposed around the central axis. The light blocking portion extends from the central opening to a direction away from the central axis, and faces towards an object side or an image side of the lens assembly. The spiral structures are disposed on the light blocking portion, and are arranged around the central axis. Each of the spiral structures includes an adaxial end close to the central axis and an abaxial end away from the central axis, and each of the spiral structures extends spirally from the adaxial end to the abaxial end by surrounding the central axis towards a direction away from the central axis. Therefore, the present disclosure provides an anti-reflection solution by arranging the spiral structures on the opaque optical element of the imaging lens assembly module, so that it is favorable for reducing the difficulty of demolding during manufacturing and for suppressing stray light from various directions so as to provide higher image quality. Further, it is also favorable for ensuring a consistent external appearance of the imaging lens assembly module.

Specifically, the opaque optical element can be a lens barrel, which has an internal space for containing the lens assembly, and the light blocking portion faces towards the object side of the lens assembly. Further, the opaque optical element can be a retainer for fixing the lens assembly. Furthermore, the opaque optical element can be a spacer for spacing lens elements of the lens assembly. The spiral structures can be arranged around the central axis continuously or intermittently, which will not be limited thereto.

The light blocking portion of the opaque optical element can face away from the lens assembly. Therefore, it is favorable for reducing the non-imaging light into the lens assembly.

The spiral structures can protrude from or recess into the light blocking portion. Therefore, it is favorable for reducing the probability of stray light. Specifically, when the spiral structures protrude from the light blocking portion, the innermost recessed region of the spiral structures can be deemed as the light blocking portion; when the spiral structures recess into the light blocking portion, the outermost protruding region of the spiral structures can be deemed as the light blocking portion, but the present disclosure will not be limited thereto.

The spiral structures and the opaque optical element can be formed integrally. Therefore, the difficulty of manufacturing can be reduced, and the producing efficiency can be increased.

Each of the spiral structures can have at least two curved surfaces. Therefore, it is favorable for simplifying the demolding process and improving the yield of the product.

The central opening can be formed by the spiral structures. Therefore, it is favorable for satisfying the light blocking requirements while enhancing the design margin of the spiral structures.

The spiral structures surround the central axis and are arranged regularly. Therefore, it is favorable for simplifying the manufacturing process and improving mass production capability.

An adaxial point is a middle point of the adaxial end of each of the spiral structures, an abaxial point is a middle point of the abaxial end; with the central axis serving as a pole of a polar coordinate system, a radius difference between the adaxial point and the abaxial point is r, and a difference of a polar angle between the adaxial point and the abaxial point is θ, the following condition is satisfied: 0.01 mm/°≤r/θ≤0.6 mm/°. Therefore, it is favorable for satisfying the image quality and increasing the design margin of the spiral structures. It should be noted that the adaxial point can be an adaxial tip or a middle point of an adaxial arc, the abaxial point can be an abaxial tip or a middle point of an abaxial arc, and the present disclosure will not be limited thereto. Further, the following condition can be satisfied: 0.015 mm/°≤r/θ≤0.45 mm/°.

When a number of the spiral structures is N, the following condition is satisfied: 3<N<365. Therefore, it is favorable for ensuring the anti-reflection performance while providing design margin for the arrangement of the spiral structures. Further, the following condition can be satisfied: 3<N<20.

A surface of each of the spiral structures has a plurality of concave-convex structures, each of the concave-convex structures protrudes from or recesses into each of the spiral structures. Therefore, the non-imaging light can be diffused for providing better signal-to-noise ratio for the image. Further, the concave-convex structures are micrometer structures and are arranged regularly. Thus, it is favorable for simplifying the fabricating process and reducing the manufacturing time.

When a shortest distance between the central opening of the opaque optical element and the central axis is D1, and a shortest distance between the spiral structures and the central axis is D2, the following condition is satisfied: 0.5≤D1/D2≤1. Therefore, it is favorable for enhancing the image quality. Further, the following condition can be satisfied: 0.65≤D1/D2<1. Further, the following condition can be satisfied: 0.85≤D1/D2<1.

Each of the spiral structures has an outer side surface facing towards the object side or the image side of the lens assembly, the outer side surface is a curved surface; with the central axis serving as a pole of a polar coordinate system, there is a height variation of the outer side surface along a direction around the central axis and away from the central axis. Therefore, it is favorable for ensuring the anti-reflection ability so as to provide design margin of the appearance of the spiral structures.

The adaxial point is the middle point of the adaxial end of each of the spiral structures, the abaxial point is the middle point of the abaxial end; with the central axis serving as the pole of the polar coordinate system, the difference of a polar angle between the adaxial point and the abaxial point is θ, the following condition is satisfied: 5°<θ<150°. Therefore, it is favorable for satisfying the anti-reflection requirement while simultaneously simplifying the manufacturing process. Further, the following condition can be satisfied: 7°≤θ≤126°.

A spiral extending path of each of the spiral structures has no overlap along a direction away from the central axis. Therefore, it is favorable for reducing the difficulty of manufacturing.

When the shortest distance between the spiral structures and the central axis is D2, and a longest distance between the spiral structures and the central axis is Dmax, the following condition is satisfied: 1.2≤Dmax/D2≤2.9. Therefore, it is favorable for satisfying both of image quality and cost consideration. Further, the following condition can be satisfied: 1.7≤Dmax/D2≤2.7.

The present disclosure provides an imaging lens assembly module, which includes a lens assembly and a lens barrel. The lens assembly has a central axis. The lens barrel has an internal space for containing the lens assembly, and disposed along the central axis with the lens assembly. The lens barrel includes a central opening, a light blocking portion and a plurality of spiral structures. The central opening is disposed around the central axis. The light blocking portion extends from the central opening to a direction away from the central axis, and faces towards an object side of the lens assembly. The spiral structures are disposed on the light blocking portion, and are arranged around the central axis regularly, wherein the spiral structures and the lens barrel are formed integrally. Each of the spiral structures includes an adaxial end close to the central axis and an abaxial end away from the central axis, and each of the spiral structures extends spirally from the adaxial end to the abaxial end by surrounding the central axis towards a direction away from the central axis. Therefore, the present disclosure provides an anti-reflection solution by arranging the spiral structures on the lens barrel of the imaging lens assembly module, so that it is favorable for reducing the difficulty of demolding during manufacturing and for suppressing stray light from various directions so as to provide higher image quality.

Each of the spiral structures can have at least two curved surfaces. Therefore, it is favorable for simplifying the demolding process and improving the yield of the product.

An adaxial point is a middle point of the adaxial end of each of the spiral structures, an abaxial point is a middle point of the abaxial end; with the central axis serving as a pole of a polar coordinate system, a radius difference between the adaxial point and the abaxial point is r, a difference of a polar angle between the adaxial point and the abaxial point is θ, the following condition is satisfied: 0.01 mm/°≤r/θ≤0.6 mm/°. Therefore, it is favorable for satisfying the image quality and increasing the design margin of the spiral structures.

The adaxial point is the middle point of the adaxial end of each of the spiral structures, the abaxial point is the middle point of the abaxial end; with the central axis serving as the pole of the polar coordinate system, the difference of a polar angle between the adaxial point and the abaxial point is θ, the following condition is satisfied: 5°<θ<150°. Therefore, it is favorable for satisfying the anti-reflection requirement while simultaneously simplifying the manufacturing process.

When a number of the spiral structures is N, the following condition is satisfied: 3<N<20. Therefore, it is favorable for ensuring the anti-reflection performance while providing design margin for the arrangement of the spiral structures.

When a shortest distance between the spiral structures and the central axis is D2, and a longest distance between the spiral structures and the central axis is Dmax, the following condition is satisfied: 1.7≤Dmax/D2≤2.7. Therefore, it is favorable for satisfying both of image quality and cost consideration.

The present disclosure provides a camera module, which includes the aforementioned imaging lens assembly module.

The present disclosure provides an electronic device, which includes the aforementioned camera module.

### 1st Embodiment

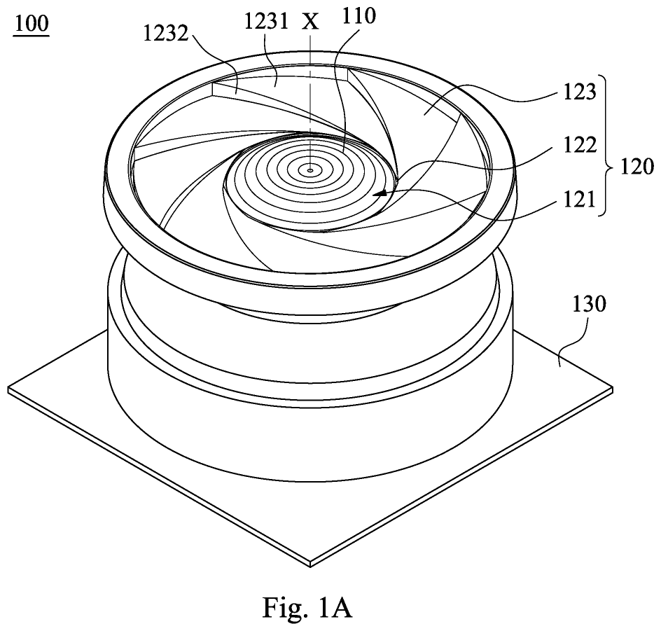

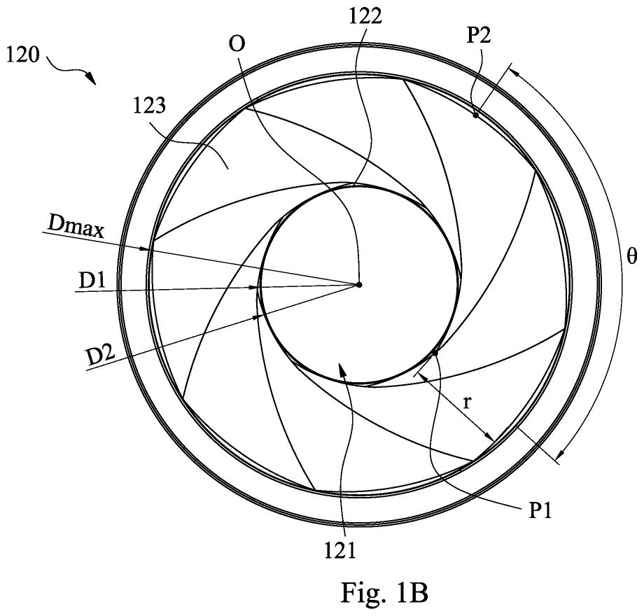

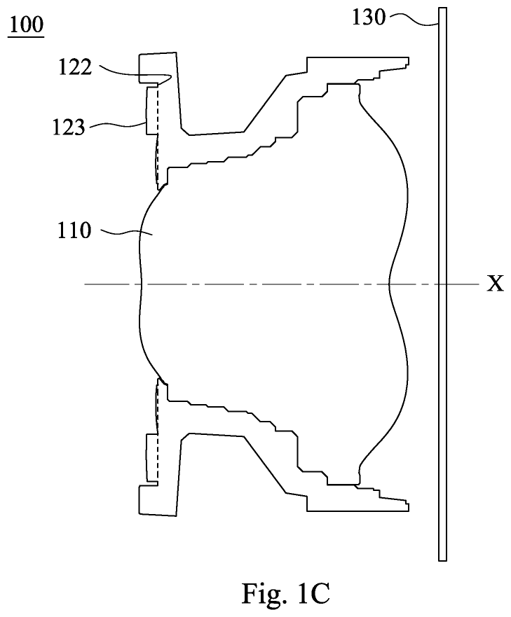

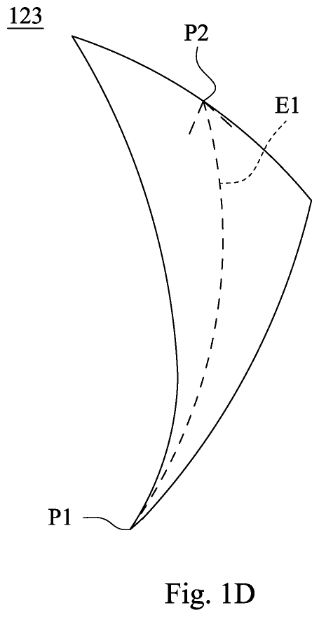

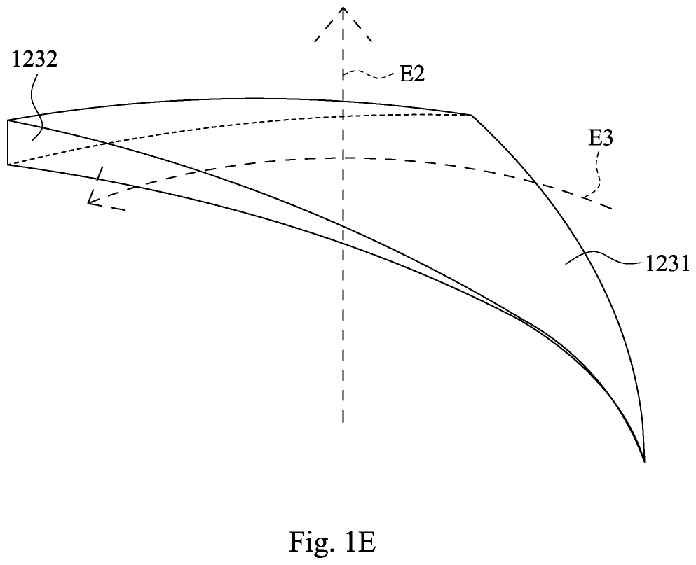

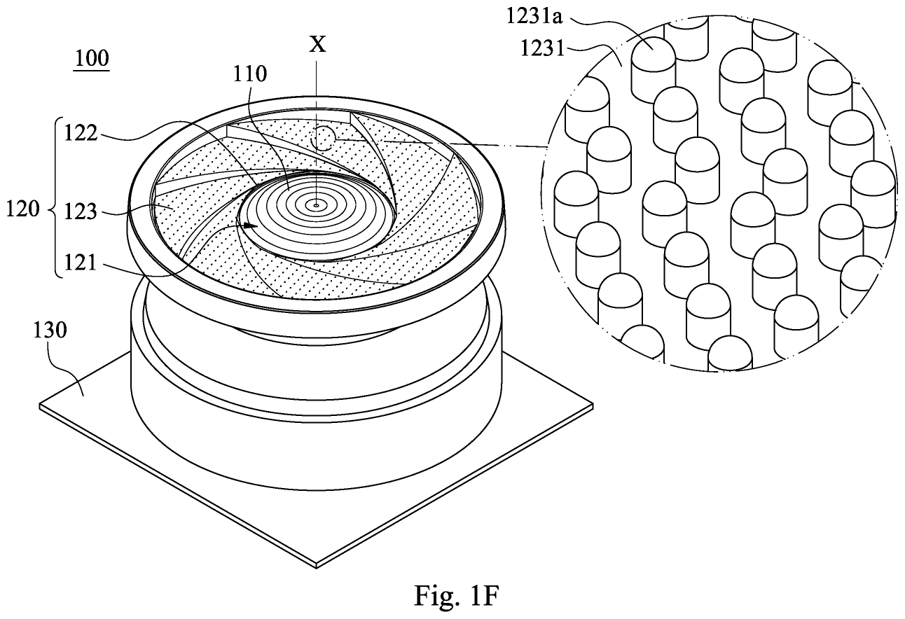

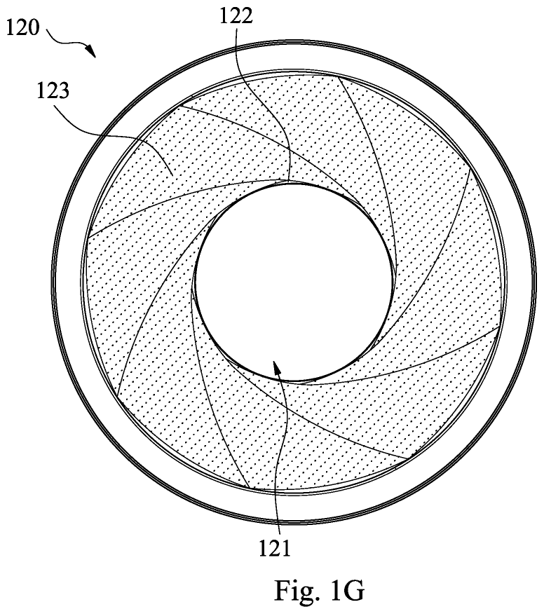

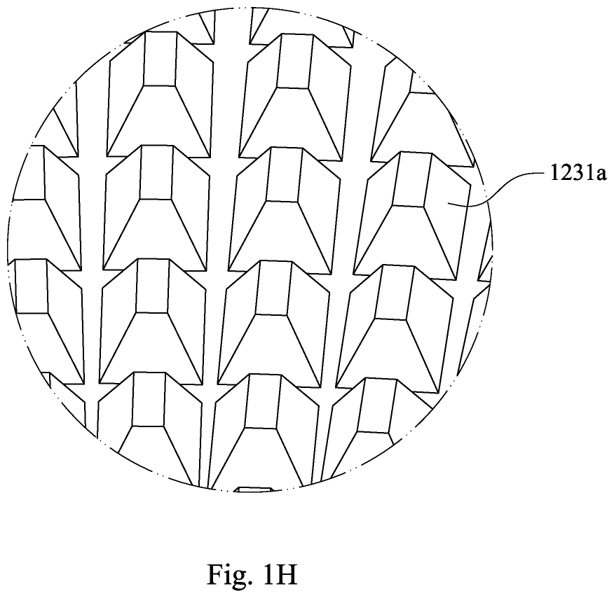

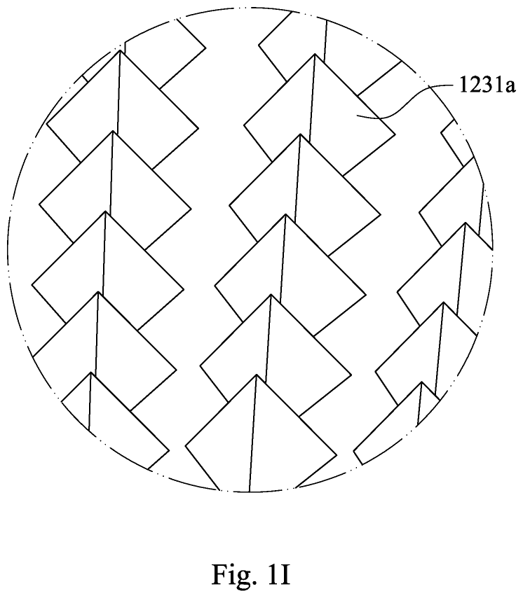

FIG. 1A is a three-dimensional view of an imaging lens assembly module 100 of the 1st example according to the 1st embodiment of the present disclosure. FIG. 1B is a front view of an opaque optical element 120 of FIG. 1A. FIG. 1C is a plane view of the imaging lens assembly module 100 of FIG. 1A. In FIG. 1A to FIG. 1C, the imaging lens assembly module 100 includes a lens assembly 110 and the opaque optical element 120, wherein the opaque optical element 120 is disposed along a central axis X with the lens assembly 110. The opaque optical element 120 is a lens barrel, which has an internal space for containing the lens assembly 110. The imaging light enters from a central opening 121 of the opaque optical element 120, and then passes through the lens assembly 110 so as to image on the image surface 130.

The opaque optical element 120 includes the central opening 121, a light blocking portion 122 and a plurality of spiral structures 123. The central opening 121 is disposed around the central axis X. The light blocking portion 122 extends from the central opening 121 to a direction away from the central axis X, and faces towards an object side of the lens assembly 110. The light blocking portion 122 of the opaque optical element 120 faces away from the lens assembly 110.

FIG. 1D is a plane view of the spiral structures 123 of FIG. 1A. FIG. 1E is a three-dimensional view of the spiral structures 123 of FIG. 1A. The spiral structures 123 are disposed on the light blocking portion 122, and are arranged around the central axis X, wherein the spiral structures 123 protrude from the light blocking portion 122. Each of the spiral structures 123 includes an adaxial end close to the central axis X and an abaxial end away from the central axis X, and each of the spiral structures 123 extends spirally from the adaxial end to the abaxial end by surrounding the central axis X towards a direction away from the central axis X (that is, the direction E1 in FIG. 1D). A spiral extending path of each of the spiral structures 123 has no overlap along a direction away from the central axis X. It should be noted that the light blocking portion 122 and the spiral structures 123 are formed integrally, the dotted lines in FIG. 1C show the boundary between the light blocking portion 122 and the spiral structures 123, which is not the actual structure.

Each of the spiral structures 123 has an outer side surface 1231 and an axial surface 1232. In FIG. 1E, according to the 1st example of the 1st embodiment, both of the outer side surface 1231 and the axial surface 1232 are curved. In detail, the outer side surface 1231 faces towards the object side of the lens assembly 110. With the central axis X serving as a pole O of a polar coordinate system, there is a height variation of the outer side surface 1231 along a direction around the central axis X (that is, the direction E3 in FIG. 1E) and away from the central axis X (that is, the direction E2 in FIG. 1E).

In FIG. 1B and FIG. 1D, according to the 1st example of the 1st embodiment, a number of the spiral structures 123 is N, a shortest distance between the central opening 121 of the opaque optical element 120 and the central axis X is D1, a shortest distance between the spiral structures 123 and the central axis X is D2, a longest distance between the spiral structures 123 and the central axis X is Dmax, an adaxial point P1 is a middle point of the adaxial end of each of the spiral structures 123, an abaxial point P2 is a middle point of the abaxial end; with the central axis X serving as the pole O of the polar coordinate system, a radius difference between the adaxial point P1 and the abaxial point P2 is r, a difference of a polar angle between the adaxial point P1 and the abaxial point P2 is θ, the values in Table 1A are satisfied.

TABLE 1A
the 1st example of the 1st embodiment

| | | | |
|---|---|---|---|
| N | 8 | Dmax/D2 | 2.13 |
| D1 | 2.53 | r | 2.67 |
| | mm | | mm |
| D2 | 2.55 | θ | 97º |
| | mm | | |
| Dmax | 5.42 | r/θ | 0.028 |
| | mm | | mm/° |
| D1/D2 | 0.99 | | |

FIG. 1F is a three-dimensional view of an imaging lens assembly module 100 of the 2nd example according to the 1st embodiment of the present disclosure. FIG. 1G is a front view of an opaque optical element 120 of FIG. 1F. In FIG. 1F and FIG. 1G, the differences between the imaging lens assembly module 100 of the 2nd example according to the 1st embodiment and the imaging lens assembly module 100 of the 1st example according to the 1st embodiment in FIG. 1A and FIG. 1E are, the surface of the spiral structures 123 (that is, the outer side surface 1231) in the imaging lens assembly module 100 of the 2nd example according to the 1st embodiment has a plurality of concave-convex structures 1231a, each of the concave-convex structures 1231a protrudes from each of the spiral structures 123. Specifically, in FIG. 1F, the concave-convex structures 1231a are micrometer structures and are arranged regularly, but will not be limited thereto.

The structures of others elements and the relationships and parameters thereof according to the 2nd example of the 1st embodiment can be the same with or similar to the corresponding features in the 1st example of the 1st embodiment, and will not be limited thereto.

FIG. 1H is a schematic view of concave-convex structures 1231a of the 3rd example according to the 1st embodiment of the present disclosure. FIG. 1I is a schematic view of concave-convex structures 1231a of the 4th example according to the 1st embodiment of the present disclosure. In FIG. 1H and FIG. 1I, the shape of the concave-convex structures 1231a according to each of the 3rd example and 4th example of the 1st embodiment can be different with the shape of the concave-convex structures 1231a according to the 2nd example of the 1st embodiment, which can also be micrometer structures and are arranged regularly.

The structures of others elements and the relationships and parameters thereof according to each of the 3rd example and 4th example of the 1st embodiment can be the same with or similar to the corresponding features in the 1st example or 2nd example of the 1st embodiment, and will not be limited thereto.

### 2nd Embodiment

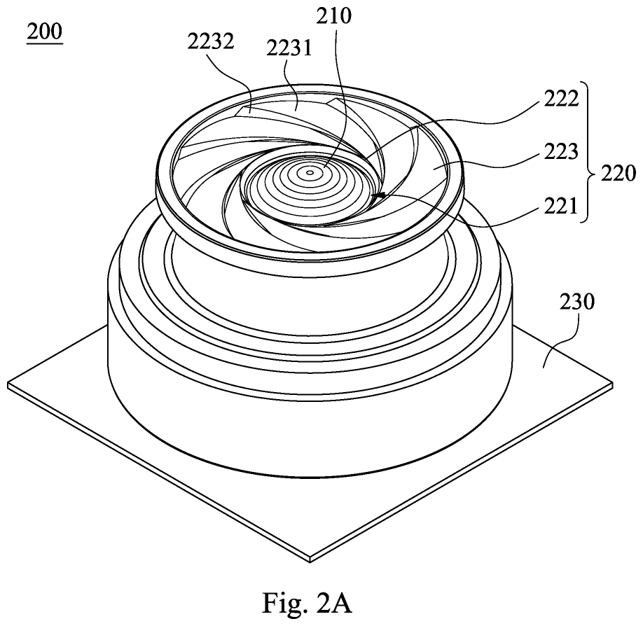

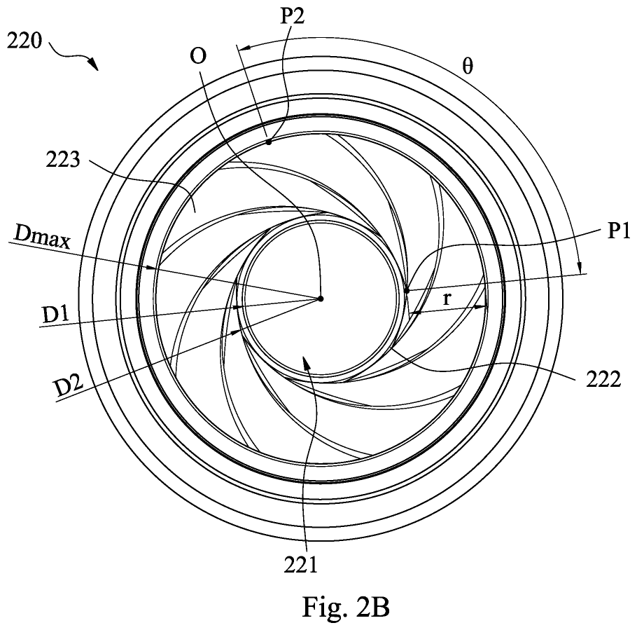

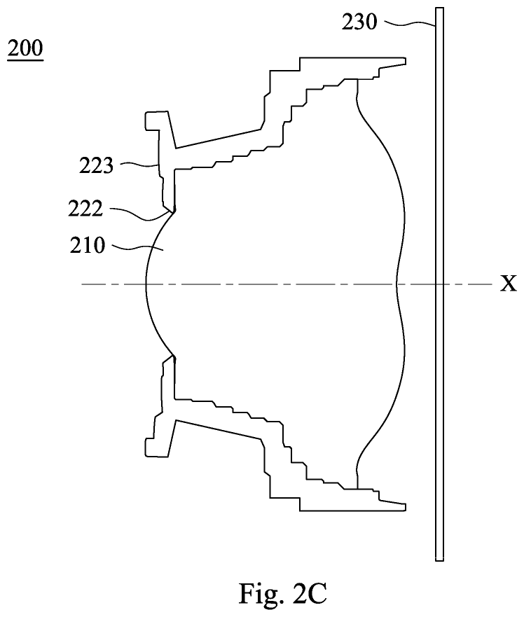

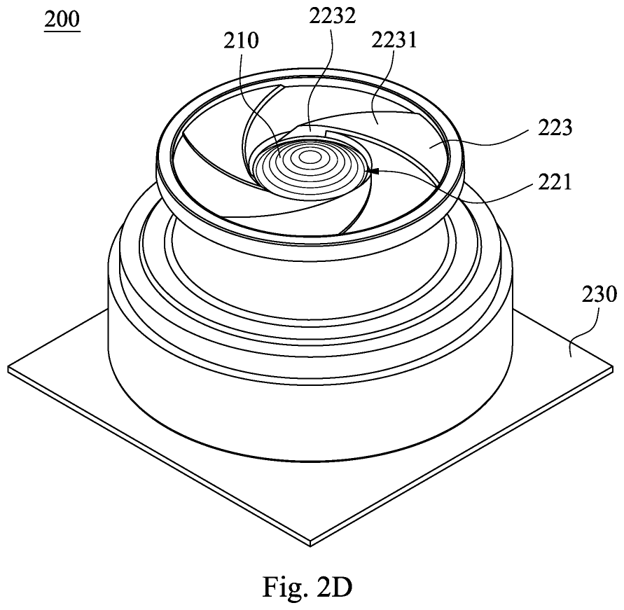

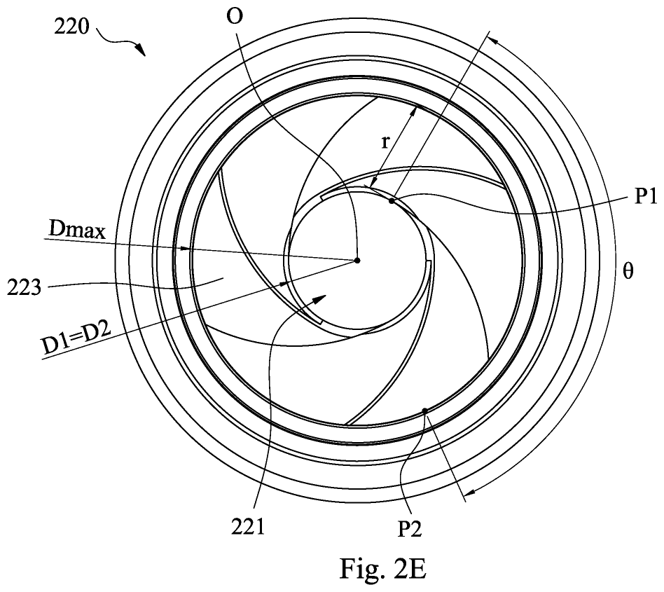

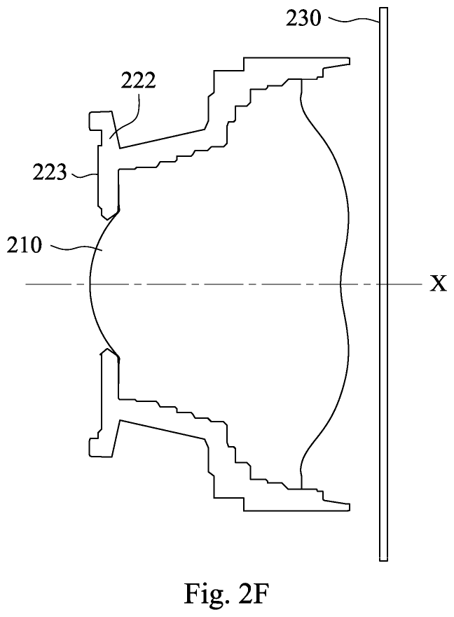

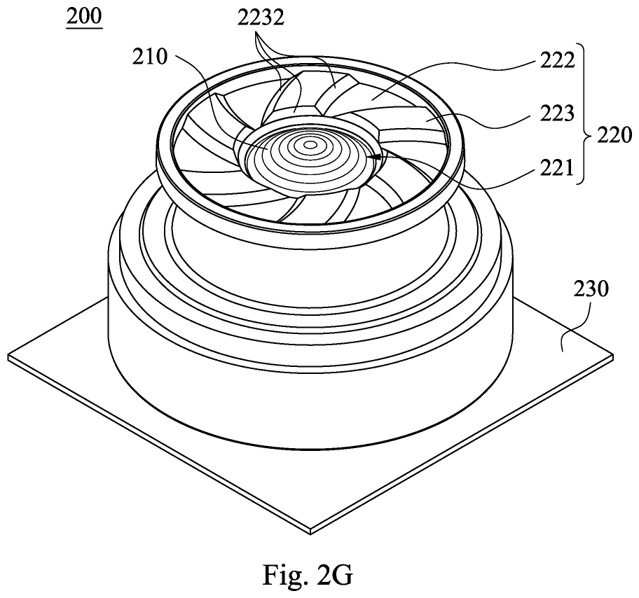

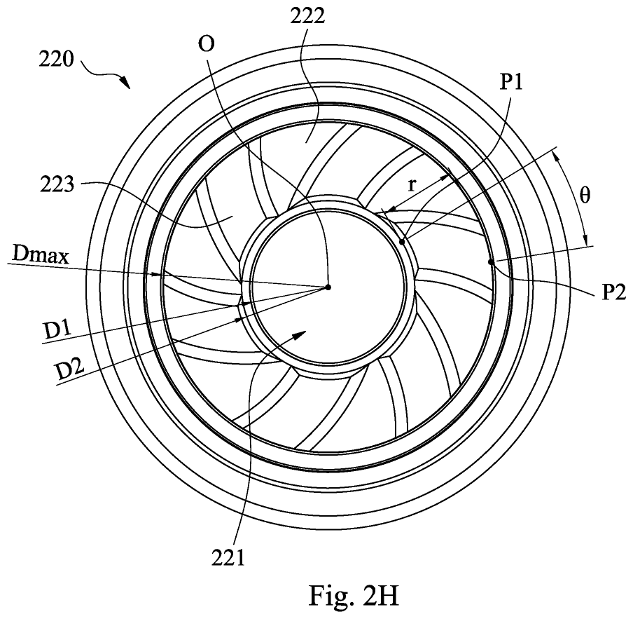

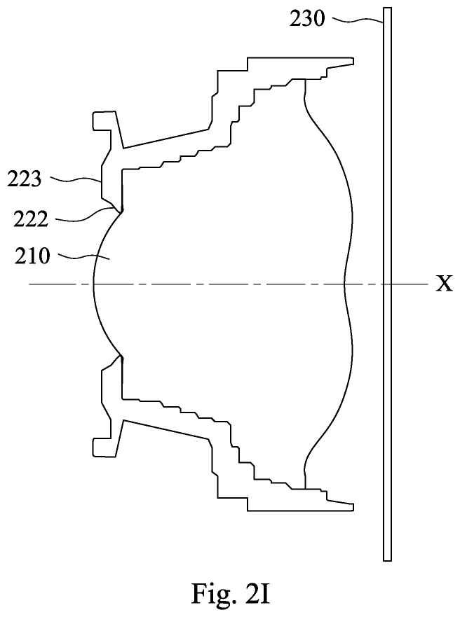

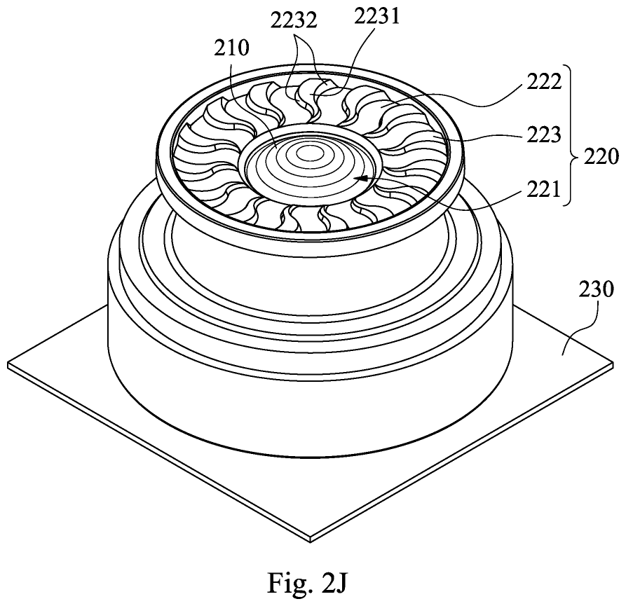

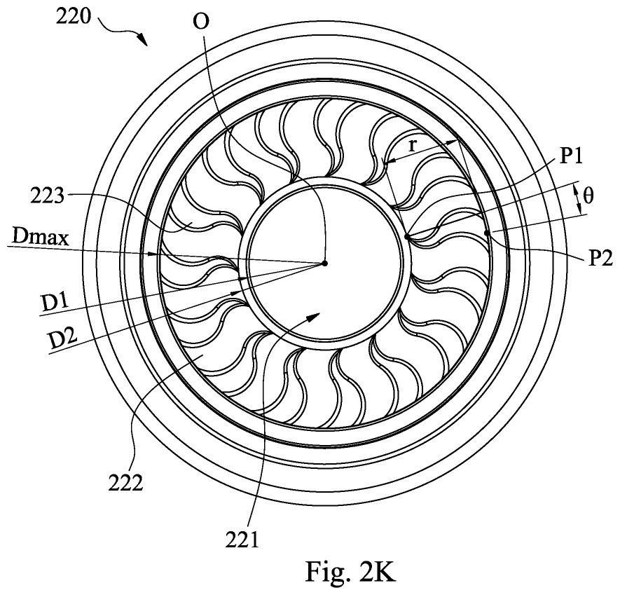

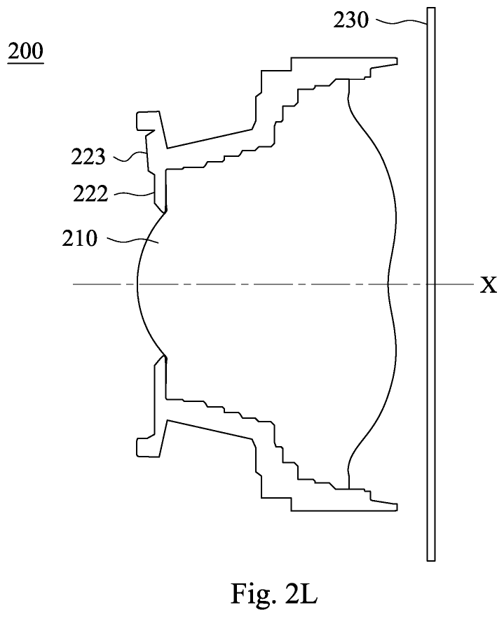

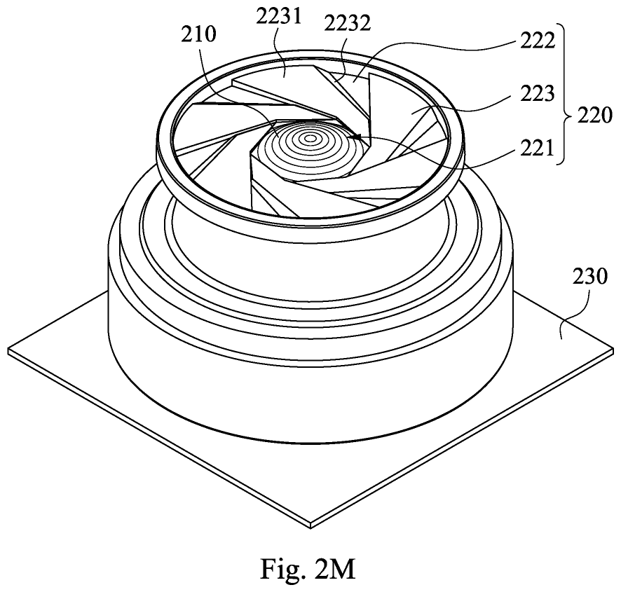

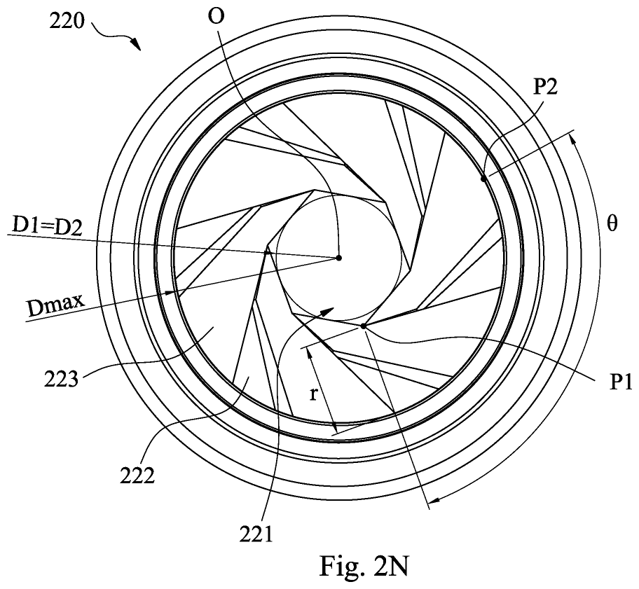

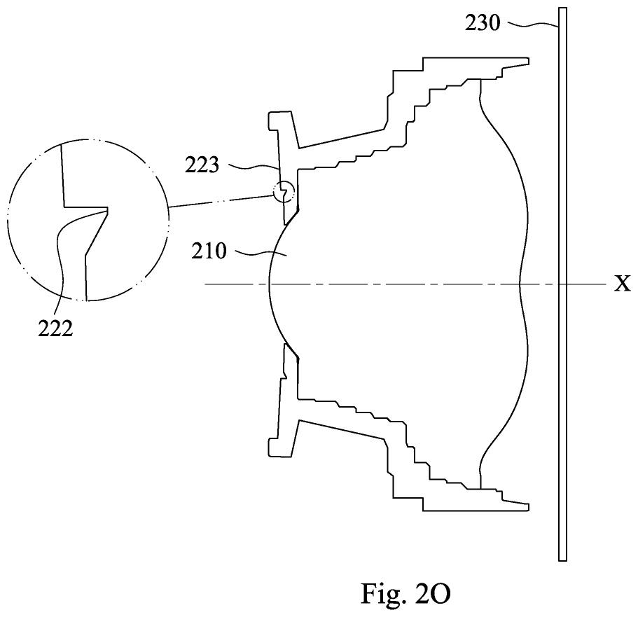

FIG. 2A is a three-dimensional view of an imaging lens assembly module 200 of the 1st example according to the 2nd embodiment of the present disclosure. FIG. 2B is a front view of an opaque optical element 220 of FIG. 2A. FIG. 2C is a plane view of the imaging lens assembly module 200 of FIG. 2A. In FIG. 2A to FIG. 2C, the imaging lens assembly module 200 includes a lens assembly 210 and the opaque optical element 220, wherein the opaque optical element 220 is disposed along a central axis X with the lens assembly 210. The opaque optical element 220 is a lens barrel, which has an internal space for containing the lens assembly 210. The imaging light enters from a central opening 221 of the opaque optical element 220, and then passes through the lens assembly 210 so as to image on the image surface 230.

The opaque optical element 220 includes the central opening 221, a light blocking portion 222 and a plurality of spiral structures 223. The central opening 221 is disposed around the central axis X. The light blocking portion 222 extends from the central opening 221 to a direction away from the central axis X, and faces towards an object side of the lens assembly 210. The light blocking portion 222 of the opaque optical element 220 faces away from the lens assembly 210.

The spiral structures 223 are disposed on the light blocking portion 222, and are arranged around the central axis X, wherein the spiral structures 223 protrude from the light blocking portion 222. Each of the spiral structures 223 includes an adaxial end close to the central axis X and an abaxial end away from the central axis X, and each of the spiral structures 223 extends spirally from the adaxial end to the abaxial end by surrounding the central axis X towards a direction away from the central axis X. A spiral extending path of each of the spiral structures 223 has no overlap along a direction away from the central axis X.

Each of the spiral structures 223 has an outer side surface 2231 and an axial surface 2232, wherein both of the outer side surface 2231 and the axial surface 2232 are curved. In detail, the outer side surface 2231 faces towards the object side of the lens assembly 210. With the central axis X serving as a pole O of a polar coordinate system, there is a height variation of the outer side surface 2231 along a direction around the central axis X and away from the central axis X.

In FIG. 2B, according to the 1st example of the 2nd embodiment, a number of the spiral structures 223 is N, a shortest distance between the central opening 221 of the opaque optical element 220 and the central axis X is D1, a shortest distance between the spiral structures 223 and the central axis X is D2, a longest distance between the spiral structures 223 and the central axis X is Dmax, an adaxial point P1 is a middle point of the adaxial end of each of the spiral structures 223, an abaxial point P2 is a middle point of the abaxial end; with the central axis X serving as the pole O of the polar coordinate system, a radius difference between the adaxial point P1 and the abaxial point P2 is r, a difference of a polar angle between the adaxial point P1 and the abaxial point P2 is θ, the values in Table 2A are satisfied.

TABLE 2A
the 1st example of the 2nd embodiment

| | | | |
|---|---|---|---|
| N | 9 | Dmax/D2 | 1.97 |
| D1 | 1.91 mm | r | 1.97 mm |
| D2 | 2.11 mm | θ | 103° |
| Dmax | 4.15 mm | r/θ | 0.019 mm/° |
| D1/D2 | 0.91 | | |

FIG. 2D is a three-dimensional view of an imaging lens assembly module 200 of the 2nd example according to the 2nd embodiment of the present disclosure. FIG. 2E is a front view of an opaque optical element 220 of FIG. 2D. FIG. 2F is a plane view of the imaging lens assembly module 200 of FIG. 2D. In FIG. 2D to FIG. 2F, the imaging lens assembly module 200 includes a lens assembly 210 and the opaque optical element 220, wherein the opaque optical element 220 is disposed along a central axis X with the lens assembly 210. The opaque optical element 220 is a lens barrel, which has an internal space for containing the lens assembly 210. The imaging light enters from a central opening 221 of the opaque optical element 220, and then passes through the lens assembly 210 so as to image on the image surface 230.

The opaque optical element 220 includes the central opening 221, a light blocking portion 222 and a plurality of spiral structures 223. The central opening 221 is disposed around the central axis X. The light blocking portion 222 extends from the central opening 221 to a direction away from the central axis X, and faces towards an object side of the lens assembly 210. The light blocking portion 222 of the opaque optical element 220 faces away from the lens assembly 210.

The spiral structures 223 are disposed on the light blocking portion 222, and are arranged around the central axis X, wherein the spiral structures 223 protrude from the light blocking portion 222, and the central opening 221 is formed by the spiral structures 223. Each of the spiral structures 223 includes an adaxial end close to the central axis X and an abaxial end away from the central axis X, and each of the spiral structures 223 extends spirally from the adaxial end to the abaxial end by surrounding the central axis X towards a direction away from the central axis X. A spiral extending path of each of the spiral structures 223 has no overlap along a direction away from the central axis X.

Each of the spiral structures 223 has an outer side surface 2231 and an axial surface 2232, wherein the axial surface 2232 is curved. In detail, the outer side surface 2231 faces towards the object side of the lens assembly 210.

In FIG. 2E, according to the 2nd example of the 2nd embodiment, a number of the spiral structures 223 is N, a shortest distance between the central opening 221 of the opaque optical element 220 and the central axis X is D1, a shortest distance between the spiral structures 223 and the central axis X is D2, a longest distance between the spiral structures 223 and the central axis X is Dmax, an adaxial point P1 is a middle point of the adaxial end of each of the spiral structures 223, an abaxial point P2 is a middle point of the abaxial end; with the central axis X serving as the pole O of the polar coordinate system, a radius difference between the adaxial point P1 and the abaxial point P2 is r, a difference of a polar angle between the adaxial point P1 and the abaxial point P2 is θ, the values in Table 2B are satisfied.

TABLE 2B
the 2nd example of the 2nd embodiment

| | | | |
|---|---|---|---|
| N | 6 | Dmax/D2 | 2.40 |
| D1 | 1.73 mm | r | 2.42 mm |
| D2 | 1.73 mm | θ | 126° |
| Dmax | 4.15 mm | r/θ | 0.019 mm/° |
| D1/D2 | 1.00 | | |

FIG. 2G is a three-dimensional view of an imaging lens assembly module 200 of the 3rd example according to the 2nd embodiment of the present disclosure. FIG. 2H is a front view of an opaque optical element 220 of FIG. 2G. FIG. 2I is a plane view of the imaging lens assembly module 200 of FIG. 2G. In FIG. 2G to FIG. 2I, the imaging lens assembly module 200 includes a lens assembly 210 and the opaque optical element 220, wherein the opaque optical element 220 is disposed along a central axis X with the lens assembly 210. The opaque optical element 220 is a lens barrel, which has an internal space for containing the lens assembly 210. The imaging light enters from a central opening 221 of the opaque optical element 220, and then passes through the lens assembly 210 so as to image on the image surface 230.

The opaque optical element 220 includes the central opening 221, a light blocking portion 222 and a plurality of spiral structures 223. The central opening 221 is disposed around the central axis X. The light blocking portion 222 extends from the central opening 221 to a direction away from the central axis X, and faces towards an object side of the lens assembly 210. The light blocking portion 222 of the opaque optical element 220 faces away from the lens assembly 210.

The spiral structures 223 are disposed on the light blocking portion 222, and are arranged around the central axis X, wherein the spiral structures 223 protrude from the light blocking portion 222. Each of the spiral structures 223 includes an adaxial end close to the central axis X and an abaxial end away from the central axis X, and each of the spiral structures 223 extends spirally from the adaxial end to the abaxial end by surrounding the central axis X towards a direction away from the central axis X. A spiral extending path of each of the spiral structures 223 has no overlap along a direction away from the central axis X.

Each of the spiral structures 223 has three axial surfaces 2232, which are curved.

In FIG. 2H, according to the 3rd example of the 2nd embodiment, a number of the spiral structures 223 is N, a shortest distance between the central opening 221 of the opaque optical element 220 and the central axis X is D1, a shortest distance between the spiral structures 223 and the central axis X is D2, a longest distance between the spiral structures 223 and the central axis X is Dmax, an adaxial point P1 is a middle point of the adaxial end of each of the spiral structures 223, an abaxial point P2 is a middle point of the abaxial end; with the central axis X serving as the pole O of the polar coordinate system, a radius difference between the adaxial point P1 and the abaxial point P2 is r, a difference values in Table 2C are satisfied.

TABLE 2C
the 3rd example of the 2nd embodiment

| | | | |
|---|---|---|---|
| N | 6 | Dmax/D2 | 1.90 |
| D1 | 1.91 mm | r | 1.97 mm |
| D2 | 2.18 mm | θ | 23° |
| Dmax | 4.15 mm | r/θ | 0.086 mm/° |
| D1/D2 | 0.88 | | |

FIG. 2J is a three-dimensional view of an imaging lens assembly module 200 of the 4th example according to the 2nd embodiment of the present disclosure. FIG. 2K is a front view of an opaque optical element 220 of FIG. 2J. FIG. 2L is a plane view of the imaging lens assembly module 200 of FIG. 2J. In FIG. 2J to FIG. 2L, the imaging lens assembly module 200 includes a lens assembly 210 and the opaque optical element 220, wherein the opaque optical element 220 is disposed along a central axis X with the lens assembly 210. The opaque optical element 220 is a lens barrel, which has an internal space for containing the lens assembly 210. The imaging light enters from a central opening 221 of the opaque optical element 220, and then passes through the lens assembly 210 so as to image on the image surface 230.

The opaque optical element 220 includes the central opening 221, a light blocking portion 222 and a plurality of spiral structures 223. The central opening 221 is disposed around the central axis X. The light blocking portion 222 extends from the central opening 221 to a direction away from the central axis X, and faces towards an object side of the lens assembly 210. The light blocking portion 222 of the opaque optical element 220 faces away from the lens assembly 210.

The spiral structures 223 are disposed on the light blocking portion 222, and are arranged around the central axis X, wherein the spiral structures 223 protrude from the light blocking portion 222. Each of the spiral structures 223 includes an adaxial end close to the central axis X and an abaxial end away from the central axis X, and each of the spiral structures 223 extends spirally from the adaxial end to the abaxial end by surrounding the central axis X towards a direction away from the central axis X.

Each of the spiral structures 223 has an outer side surface 2231 and two axial surfaces 2232, wherein all of the outer side surface 2231 and the axial surfaces 2232 are curved. In detail, the outer side surface 2231 faces towards the object side of the lens assembly 210. With the central axis X serving as a pole O of a polar coordinate system, there is a height variation of the outer side surface 2231 along a direction around the central axis X and away from the central axis X.

In FIG. 2K, according to the 4th example of the 2nd embodiment, a number of the spiral structures 223 is N, a shortest distance between the central opening 221 of the opaque optical element 220 and the central axis X is D1, a shortest distance between the spiral structures 223 and the central axis X is D2, a longest distance between the spiral structures 223 and the central axis X is Dmax, an adaxial point P1 is a middle point of the adaxial end of each of the spiral structures 223, an abaxial point P2 is a middle point of the abaxial end; with the central axis X serving as the pole O of the polar coordinate system, a radius difference between the adaxial point P1 and the abaxial point P2 is r, a difference values in Table 2D are satisfied.

TABLE 2D
the 4th example of the 2nd embodiment

| | | | |
|---|---|---|---|
| N | 15 | Dmax/D2 | 1.90 |
| D1 | 1.91 mm | r | 1.97 mm |
| D2 | 2.18 mm | θ | 7° |
| Dmax | 4.15 mm | r/θ | 0.281 mm/° |
| D1/D2 | 0.88 | | |

FIG. 2M is a three-dimensional view of an imaging lens assembly module 200 of the 5th example according to the 2nd embodiment of the present disclosure. FIG. 2N is a front view of an opaque optical element 220 of FIG. 2M. FIG. 2O is a plane view of the imaging lens assembly module 200 of FIG. 2M. In FIG. 2M to FIG. 2O, the imaging lens assembly module 200 includes a lens assembly 210 and the opaque optical element 220, wherein the opaque optical element 220 is disposed along a central axis X with the lens assembly 210. The opaque optical element 220 is a lens barrel, which has an internal space for containing the lens assembly 210. The imaging light enters from a central opening 221 of the opaque optical element 220, and then passes through the lens assembly 210 so as to image on the image surface 230.

The opaque optical element 220 includes the central opening 221, a light blocking portion 222 and a plurality of spiral structures 223. The central opening 221 is disposed around the central axis X. The light blocking portion 222 extends from the central opening 221 to a direction away from the central axis X, and faces towards an object side of the lens assembly 210. The light blocking portion 222 of the opaque optical element 220 faces away from the lens assembly 210.

The spiral structures 223 are disposed on the light blocking portion 222, and are arranged around the central axis X, wherein the spiral structures 223 protrude from the light blocking portion 222, and the central opening 221 is formed by the spiral structures 223. Each of the spiral structures 223 includes an adaxial end close to the central axis X and an abaxial end away from the central axis X, and each of the spiral structures 223 extends spirally from the adaxial end to the abaxial end by surrounding the central axis X towards a direction away from the central axis X. Moreover, spiral extending paths of the spiral structures 223 do not overlap to each other along the direction away from the central axis X.

Each of the spiral structures 223 has an outer side surface 2231 and an axial surface 2232, wherein both of the outer side surface 2231 and the axial surface 2232 are curved. In detail, the outer side surface 2231 faces towards the object side of the lens assembly 210. With the central axis X serving as a pole O of a polar coordinate system, there is a height variation of the outer side surface 2231 along a direction around the central axis X and away from the central axis X.

In FIG. 2N, according to the 5th example of the 2nd embodiment, a number of the spiral structures 223 is N, a shortest distance between the central opening 221 of the opaque optical element 220 and the central axis X is D1, a shortest distance between the spiral structures 223 and the central axis X is D2, a longest distance between the spiral structures 223 and the central axis X is Dmax, an adaxial point P1 is a middle point of the adaxial end of each of the spiral structures 223, an abaxial point P2 is a middle point of the abaxial end; with the central axis X serving as the pole O of the polar coordinate system, a radius difference between the adaxial point P1 and the abaxial point P2 is r, a difference values in Table 2E are satisfied.

TABLE 2E
the 5th example of the 2nd embodiment

| | | | |
|---|---|---|---|
| N | 6 | Dmax/D2 | 2.63 |
| D1 | 1.58 mm | r | 2.33 mm |
| D2 | 1.58 mm | θ | 99° |
| Dmax | 4.15 mm | r/θ | 0.024 mm/° |
| D1/D2 | 1.00 | | |

### 3rd Embodiment

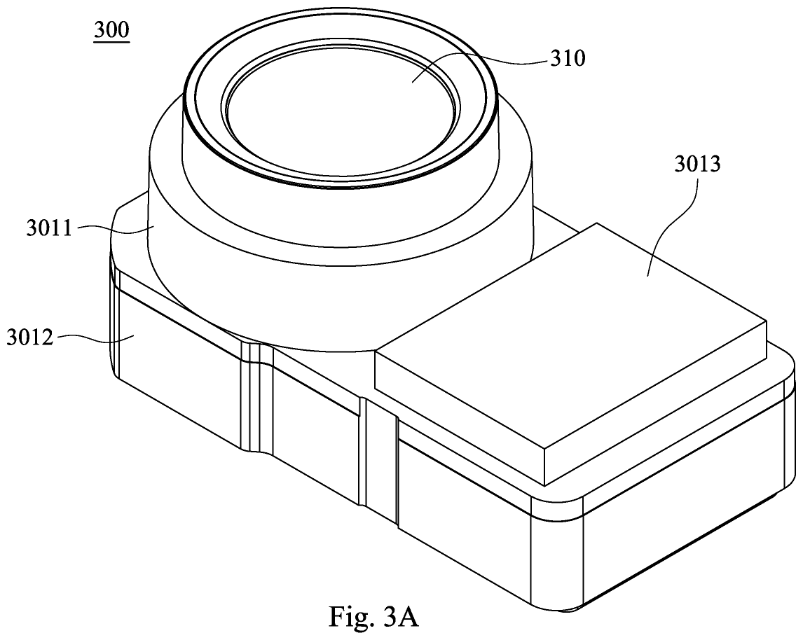

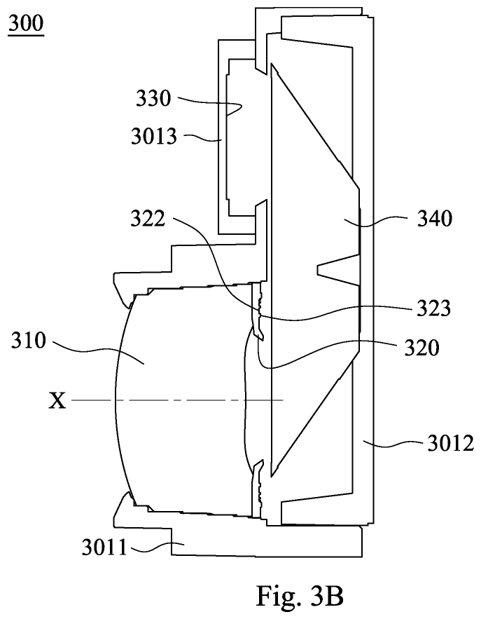

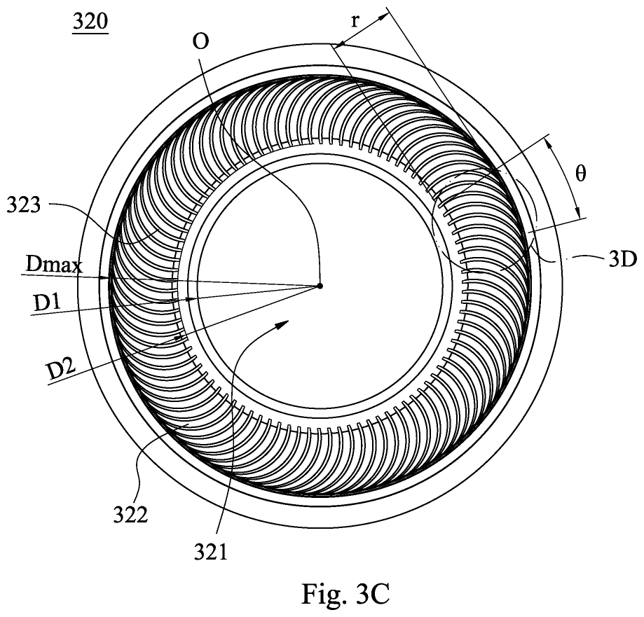

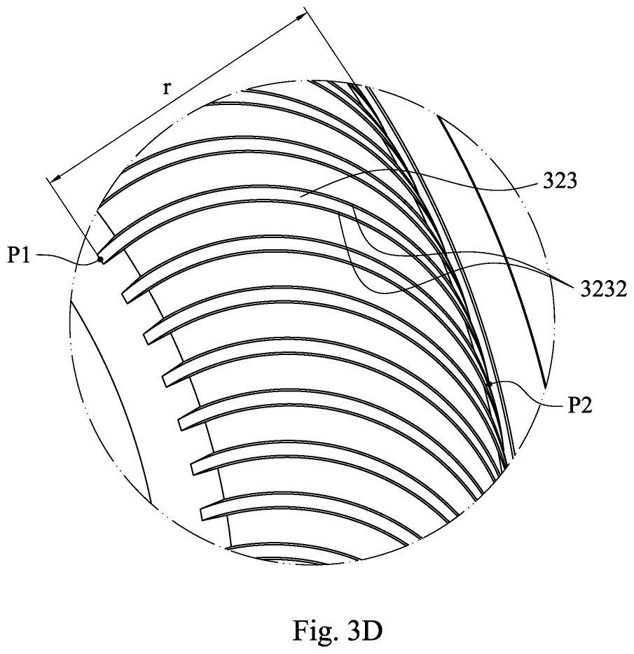

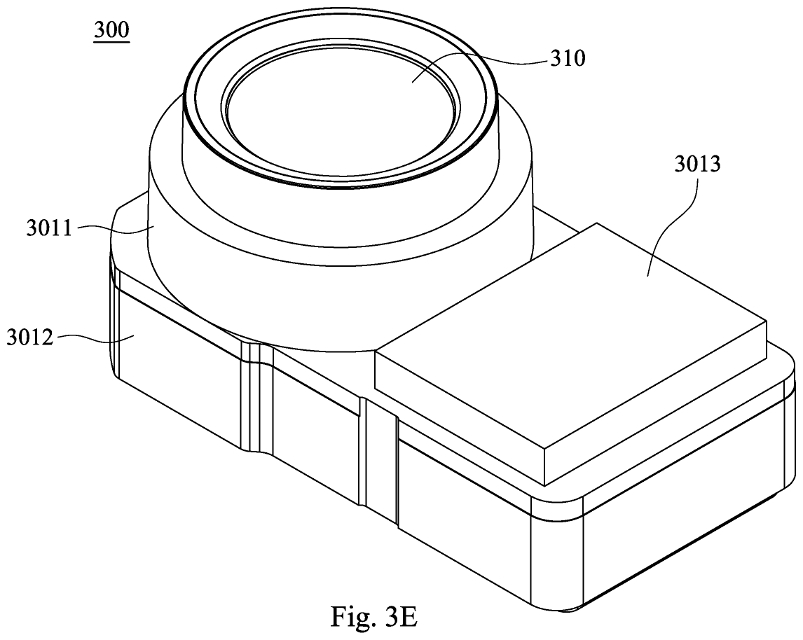

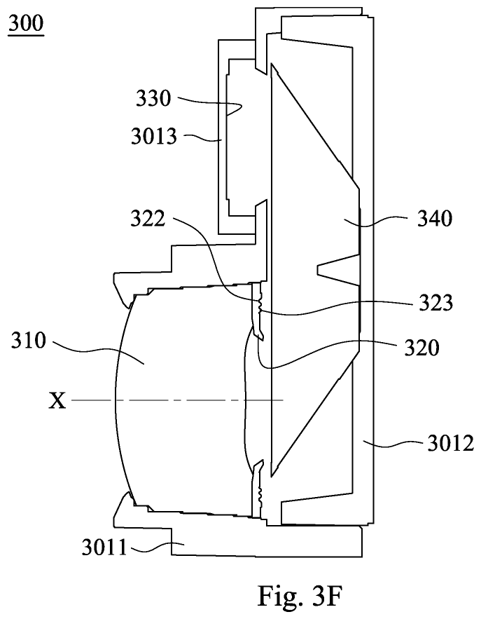

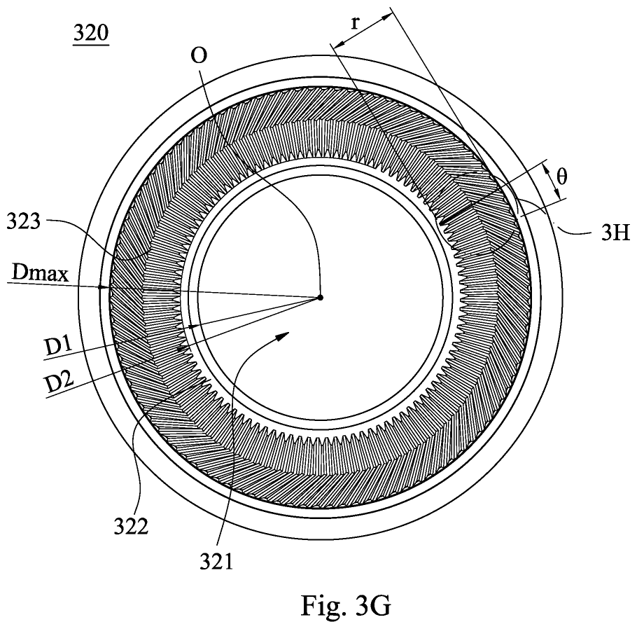

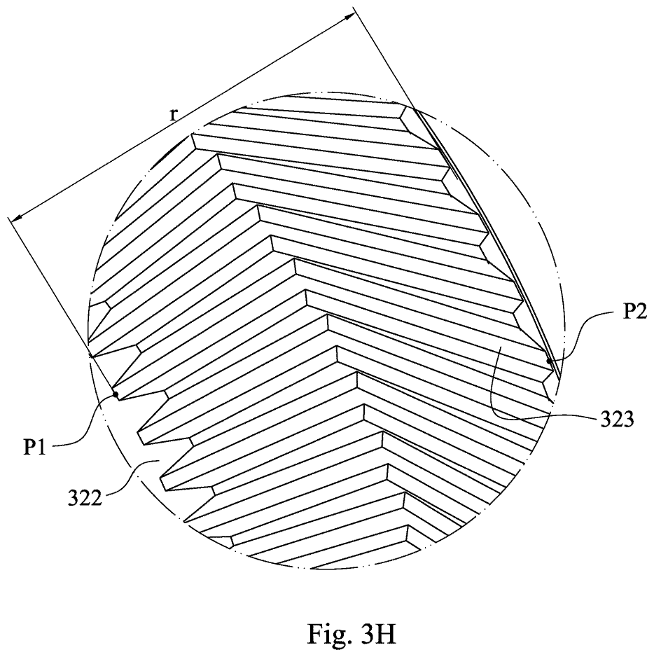

FIG. 3A is a three-dimensional view of an imaging lens assembly module 300 of the 1st example according to the 3rd embodiment of the present disclosure. FIG. 3B is a plane view of the imaging lens assembly module 300 of FIG. 3A. In FIG. 3A and FIG. 3B, the imaging lens assembly module 300 includes a lens assembly 310, the opaque optical element 320, a light folding element 340, a lens barrel 3011, an outer cover 3012 and a base 3013. The lens assembly 310 is disposed in the lens barrel 3011. The light folding element 340 is located on an image side of the lens assembly 310 and is disposed in the outer cover 3012. The base 3013 and the lens barrel 3011 are connected to the outer cover 3012. The image surface 330 is disposed on the base 3013. The imaging light enters from the lens assembly 310, and is folded via the light folding element 340 so as to image on the image surface 330. In FIG. 3B, the opaque optical element 320 is a retainer, which is disposed along the central axis X with the lens assembly 310 in the lens barrel 3011, and located on the image side of the lens assembly 310.

The opaque optical element 320 includes a central opening 321, a light blocking portion 322 and a plurality of spiral structures 323. The central opening 321 is disposed around the central axis X. The light blocking portion 322 extends from the central opening 321 to a direction away from the central axis X, and faces towards the image side of the lens assembly 310. The light blocking portion 322 of the opaque optical element 320 faces away from the lens assembly 310.

FIG. 3C is a front view of the opaque optical element 320 of FIG. 3A. FIG. 3D is an enlarged view of the spiral structures 323 in FIG. 3C. In FIG. 3C and FIG. 3D, the spiral structures 323 are disposed on the light blocking portion 322, and are arranged around the central axis X, wherein the spiral structures 323 protrude from the light blocking portion 322. Each of the spiral structures 323 includes an adaxial end close to the central axis X and an abaxial end away from the central axis X, and each of the spiral structures 323 extends spirally from the adaxial end to the abaxial end by surrounding the central axis X towards a direction away from the central axis X. A spiral extending path of each of the spiral structures 323 has no overlap along a direction away from the central axis X.

Each of the spiral structures 323 has two axial surfaces 3232, which are curved. In FIG. 3D, according to the 1st example of the 3rd embodiment, the axial surfaces 3232 are curved.

In FIG. 3C and FIG. 3D, according to the 1st example of the 3rd embodiment, a number of the spiral structures 323 is N, a shortest distance between the central opening 321 of the opaque optical element 320 and the central axis X is D1, a shortest distance between the spiral structures 323 and the central axis X is D2, a longest distance between the spiral structures 323 and the central axis X is Dmax, an adaxial point P1 is a middle point of the adaxial end of each of the spiral structures 323, an abaxial point P2 is a middle point of the abaxial end; with the central axis X serving as the pole O of the polar coordinate system, a radius difference between the adaxial point P1 and the abaxial point P2 is r, a difference of a polar angle between the adaxial point P1 and the abaxial point P2 is θ, the values in Table 3A are satisfied.

TABLE 3A
the 1st example of the 3rd embodiment

| | | | |
|---|---|---|---|
| N | 90 | Dmax/D2 | 1.47 |
| D1 | 1.98 mm | r | 1.07 mm |
| D2 | 2.29 mm | θ | 19° |
| Dmax | 3.37 mm | r/θ | 0.056 mm/° |
| D1/D2 | 0.86 | | |

FIG. 3E is a three-dimensional view of an imaging lens assembly module 300 of the 2nd example according to the 3rd embodiment of the present disclosure. FIG. 3F is a plane view of the imaging lens assembly module 300 of FIG. 3E. In FIG. 3E and FIG. 3F, the imaging lens assembly module 300 includes a lens assembly 310, the opaque optical element 320, a light folding element 340, a lens barrel 3011, an outer cover 3012 and a base 3013. The lens assembly 310 is disposed in the lens barrel 3011. The light folding element 340 is located on an image side of the lens assembly 310 and is disposed in the outer cover 3012. The base 3013 and the lens barrel 3011 are connected to the outer cover 3012. The image surface 330 is disposed on the base 3013. The imaging light enters from the lens assembly 310, and is folded via the light folding element 340 so as to image on the image surface 330. In FIG. 3F, the opaque optical element 320 is a retainer, which is disposed along the central axis X with the lens assembly 310 in the lens barrel 3011, and located on the image side of the lens assembly 310.

The opaque optical element 320 includes a central opening 321, a light blocking portion 322 and a plurality of spiral structures 323. The central opening 321 is disposed around the central axis X. The light blocking portion 322 extends from the central opening 321 to a direction away from the central axis X, and faces towards the image side of the lens assembly 310. The light blocking portion 322 of the opaque optical element 320 faces away from the lens assembly 310.

FIG. 3G is a front view of the opaque optical element 320 of FIG. 3E. FIG. 3H is an enlarged view of the spiral structures 323 in FIG. 3G. In FIG. 3G and FIG. 3H, the spiral structures 323 are disposed on the light blocking portion 322, and are arranged around the central axis X, wherein the spiral structures 323 protrude from the light blocking portion 322. Each of the spiral structures 323 includes an adaxial end close to the central axis X and an abaxial end away from the central axis X, and each of the spiral structures 323 extends spirally from the adaxial end to the abaxial end by surrounding the central axis X towards a direction away from the central axis X. A spiral extending path of each of the spiral structures 323 has no overlap along a direction away from the central axis X.

In FIG. 3G and FIG. 3H, according to the 2nd example of the 3rd embodiment, a number of the spiral structures 323 is N, a shortest distance between the central opening 321 of the opaque optical element 320 and the central axis X is D1, a shortest distance between the spiral structures 323 and the central axis X is D2, a longest distance between the spiral structures 323 and the central axis X is Dmax, an adaxial point P1 is a middle point of the adaxial end of each of the spiral structures 323, an abaxial point P2 is a middle point of the abaxial end; with the central axis X serving as the pole O of the polar coordinate system, a radius difference between the adaxial point P1 and the abaxial point P2 is r, a difference of a polar angle between the adaxial point P1 and the abaxial point P2 is θ, the values in Table 3B are satisfied.

TABLE 3B
the 2nd example of the 3rd embodiment

| | | | |
|---|---|---|---|
| N | 100 | Dmax/D2 | 1.50 |
| D1 | 1.98 mm | r | 1.13 mm |
| D2 | 2.26 mm | θ | 9° |
| Dmax | 3.39 mm | r/θ | 0.126 mm/° |
| D1/D2 | 0.88 | | |

### 4th Embodiment

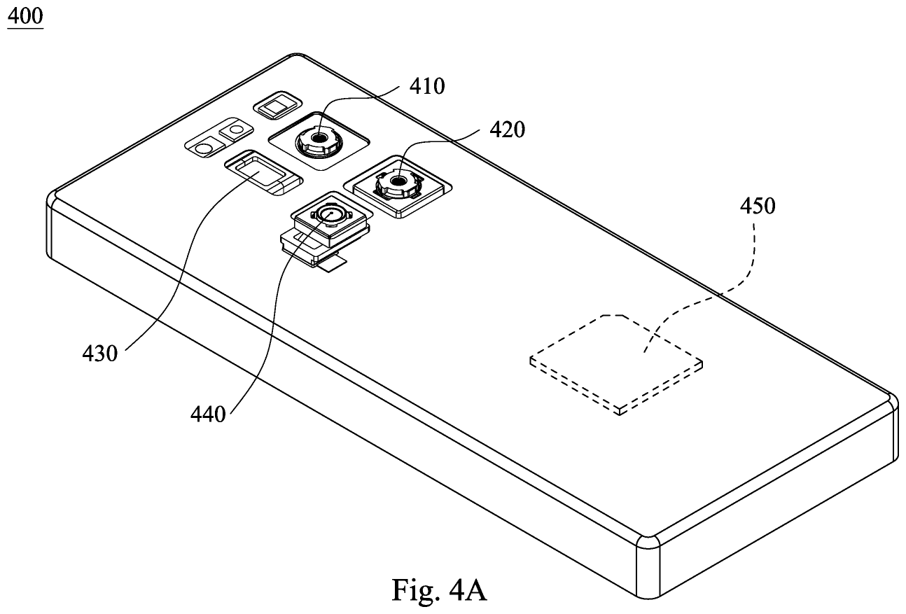

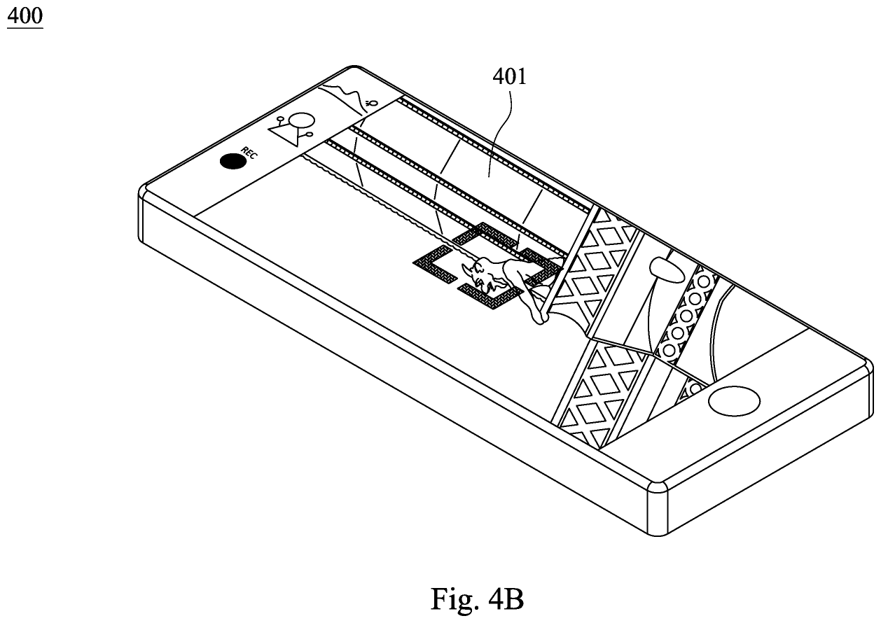

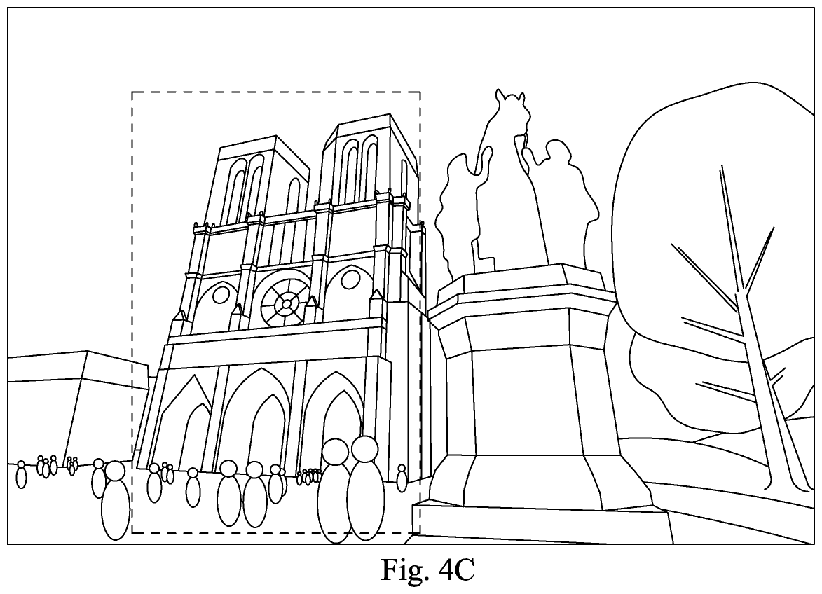

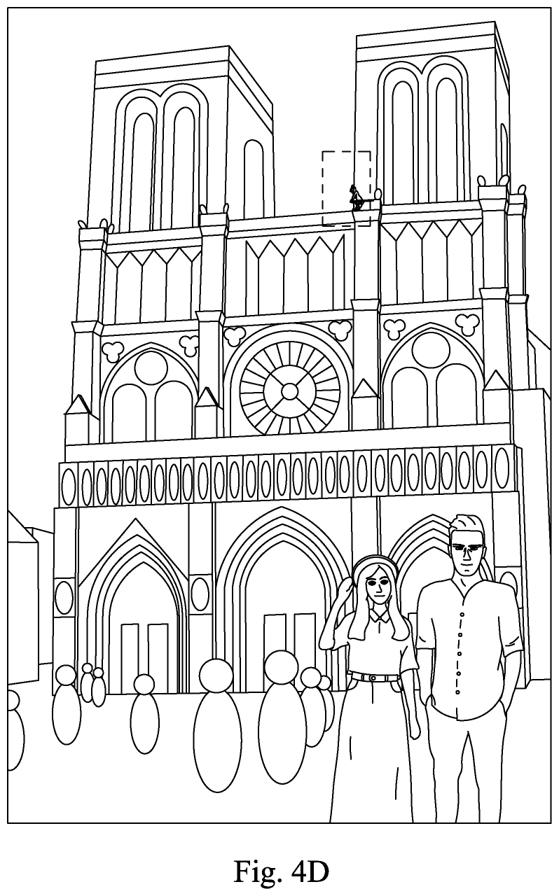

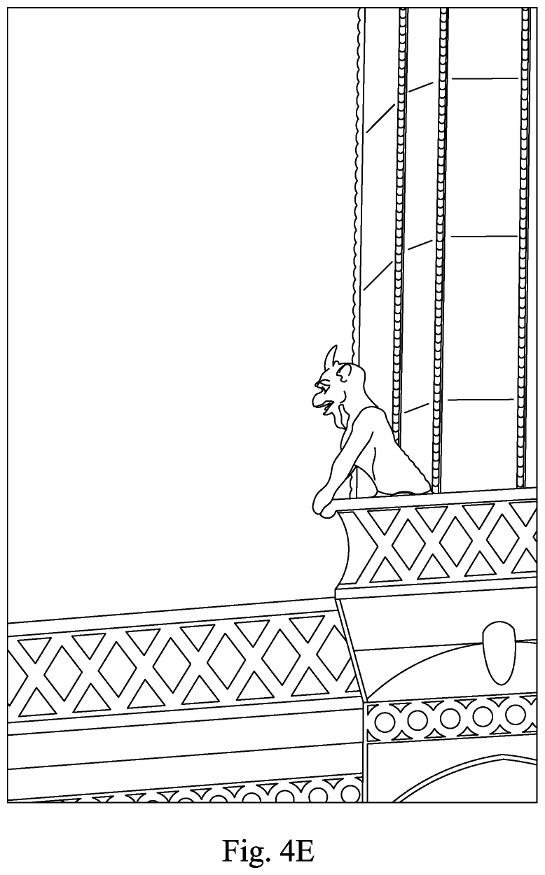

FIG. 4A is a schematic view of an electronic device 400 according to the 4th embodiment of the present disclosure. FIG. 4B is another schematic view of the electronic device 400 according to the 4th embodiment of FIG. 4A. As shown in FIG. 4A and FIG. 4B, the electronic device 400 is a smartphone. The electronic device 400 includes camera modules and a user interface 401, wherein each camera module can includes the imaging lens assembly module according to any example according to the aforementioned 1st to 3rd embodiments, but will not be limited thereto. In detail, the camera modules are a high-pixel camera module 410, an ultra-wide-angle camera module 420, and two telephoto camera modules 430, 440, and the user interface 401 is a touch screen, but the present disclosure is not limited thereto.

A user enters a shooting mode via the user interface 401. The user interface 401 is used to display the screen, and the shooting angle can be manually adjusted to switch between different camera modules. At this moment, the camera modules collect an imaging light on the respective image sensor (not shown in figures) and output electronic signals associated with images to an image signal processor (ISP) 450.

As shown in FIG. 4A, according to the camera specifications of the electronic device 400, the electronic device 400 can further include an optical anti-shake mechanism (not shown in figures). Further, the electronic device 400 can further include at least one focusing assisting module (not shown in figures) and at least one sensing component (not shown in figures). The focusing assisting module can be a flash module, an infrared distance measurement component, a laser focus module, etc. The flash module is for compensating the color temperature. The sensing component can have functions for sensing physical momentum and kinetic energies, such as an accelerator, a gyroscope, and a Hall effect element, so as to sense shaking or jitters applied by hands of the user or external environments. Thus the autofocus function and the optical anti-shake mechanism of the camera modules disposed on the electronic device 400 can function to obtain a great image quality and facilitate the electronic device 400 according to the present disclosure to have a capturing function with multiple modes, such as taking optimized selfies, high dynamic range (HDR) with a low light source, 4K resolution recording, etc. Furthermore, the user can visually see the captured image of the camera through the user interface 46 and manually operate the view finding range on the user interface 46 to achieve the auto focus function of what you see is what you get.

Furthermore, the camera modules, the optical anti-shake mechanism, the sensing component and the focusing assisting module can be disposed on a flexible printed circuit board (FPC) (not shown in figures) and electrically connected to the image signal processor 450 and so on via a connector (not shown in figures) so as to operate a picturing process. Recent electronic devices such as smartphones have a trend towards thinness and lightness. The camera modules and the related elements are disposed on a FPC and circuits are assembled into a main board of an electronic device by a connector. Hence, it can fulfill a mechanical design of a limited inner space of the electronic device and a requirement of a circuit layout and obtain a larger allowance, and it is also favorable for autofocus functions of the camera modules obtaining a flexible control via a touch screen of the electronic device. In the 4th embodiment, the electronic device 400 can include a plurality of the sensing components and a plurality of the focusing assisting modules, and the sensing components and the focusing assisting modules are disposed on an FPC and another at least one FPC (not shown in figures) and electrically connected to the image signal processor 450 and so on via a corresponding connector so as to operate a picturing process. In other embodiments (not shown in figures), the sensing components and auxiliary optical elements can be disposed on a main board of an electronic device or a board of the other form according to a mechanical design and a requirement of a circuit layout.

Furthermore, the electronic device 400 can further include, but not be limited to, a display, a control unit, a storage unit, a random-access memory (RAM), a read-only memory (ROM), or the combination thereof.

FIG. 4C is a schematic view of an image captured via the electronic device 400 according to the 4th embodiment of FIG. 4A. As shown in FIG. 4C, a larger ranged image can be captured via the ultra-wide-angle camera module 420, which has a function for containing more views.

FIG. 4D is another schematic view of the image captured via the electronic device 400 according to the 4th embodiment of FIG. 4A. As shown in FIG. 4D, a certain ranged and high-pixel image can be captured via the high-pixel camera module 410, which has a function for high resolution and low distortion.

FIG. 4E is the other schematic view of the image captured via the electronic device 400 according to the 4th embodiment of FIG. 4A. As shown in FIG. 4E, a far image can be captured and enlarged to a high magnification via the telephoto camera modules 430, 440, which has a function for a high magnification.

As shown in FIG. 4C to FIG. 4E, when an image is captured via different camera modules having various focal lengths and processed via a technology of an image processing, a zoom function of the electronic device 400 can be achieved.

### 5th Embodiment

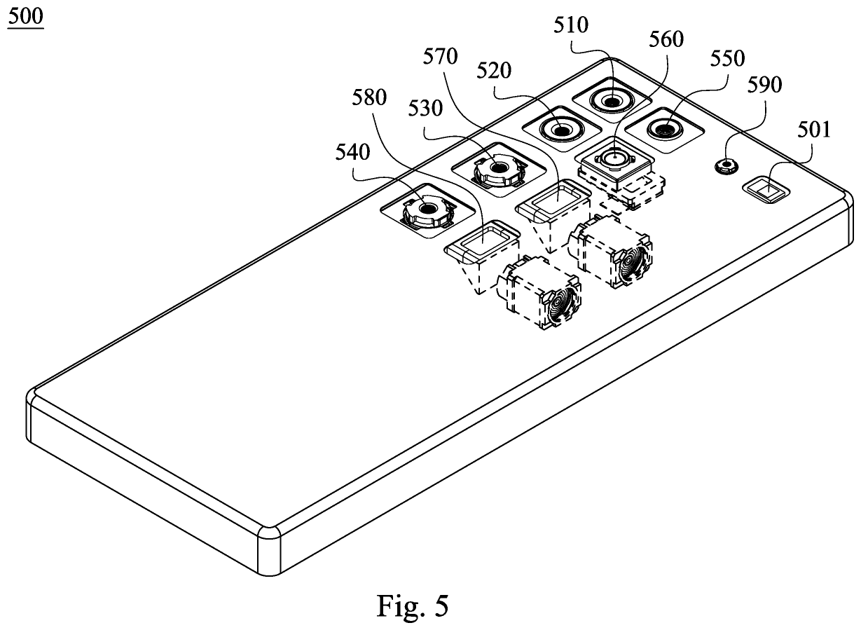

FIG. 5 is a schematic view of an electronic device 500 according to the 5th embodiment of the present disclosure. As shown in FIG. 5, the electronic device 500 is a smartphone. The electronic device 500 includes a plurality of camera modules, wherein each camera module can includes the imaging lens assembly module according to any example according to the aforementioned 1st to 3rd embodiments, but the present disclosure is not limited thereto. In detail, camera modules are two ultra-wide-angle camera modules 510, 520, two wide angle camera modules 530, 540, four telephoto camera modules 550, 560, 570, 580, and a Time-Of-Flight (TOF) module 590, the TOF module 590 can be other types of camera module, which will not be limited to the present arrangement.

Further, the camera modules 570, 580 can have folding function of the light path, but the present disclosure will not be limited thereto.

According to the camera specifications of the electronic device 500, the electronic device 500 can further include an optical anti-shake mechanism (not shown in figures). Further, the electronic device 500 can further include at least one focusing assisting module (not shown in figures) and at least one sensing component (not shown in figures). The focusing assisting module can be a flash module 501, an infrared distance measurement component, a laser focus module, etc. The flash module 501 is for compensating the color temperature. The sensing component can have functions for sensing physical momentum and kinetic energies, such as an accelerator, a gyroscope, and a Hall effect element, so as to sense shaking or jitters applied by hands of the user or external environments. Thus, the autofocus function and the optical anti-shake mechanism of the camera modules disposed on the electronic device 500 can function to obtain a great image quality and facilitate the electronic device 500 according to the present disclosure to have a capturing function with multiple modes, such as taking optimized selfies, high dynamic range (HDR) with a low light source, 4K resolution recording, etc.

Furthermore, all of other structures and dispositions according to the 5th embodiment are the same as the structures and the dispositions according to the 4th embodiment, and will not be described again herein.

### 6th Embodiment

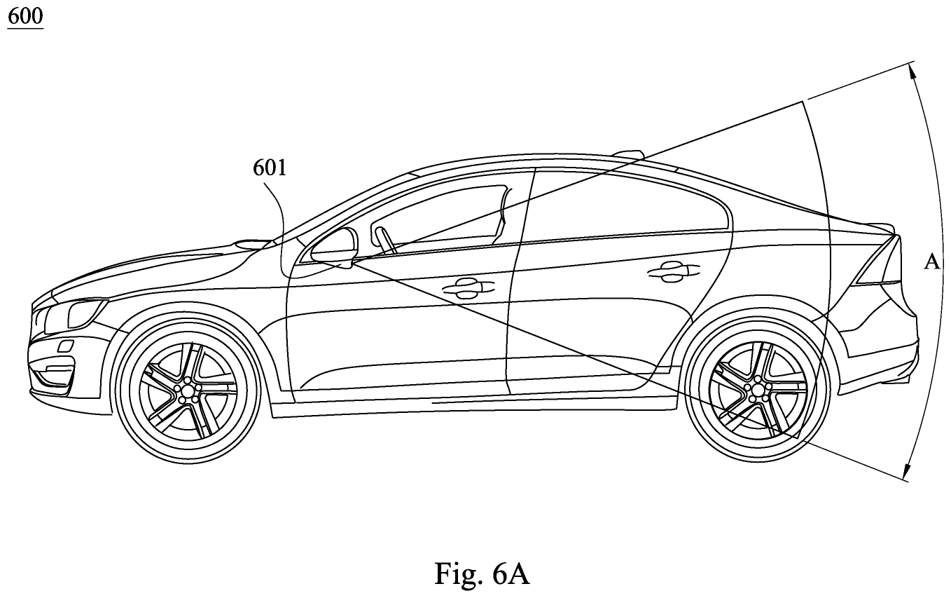

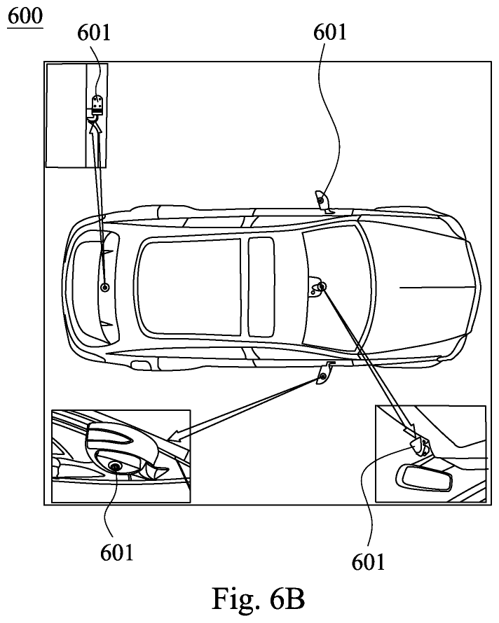

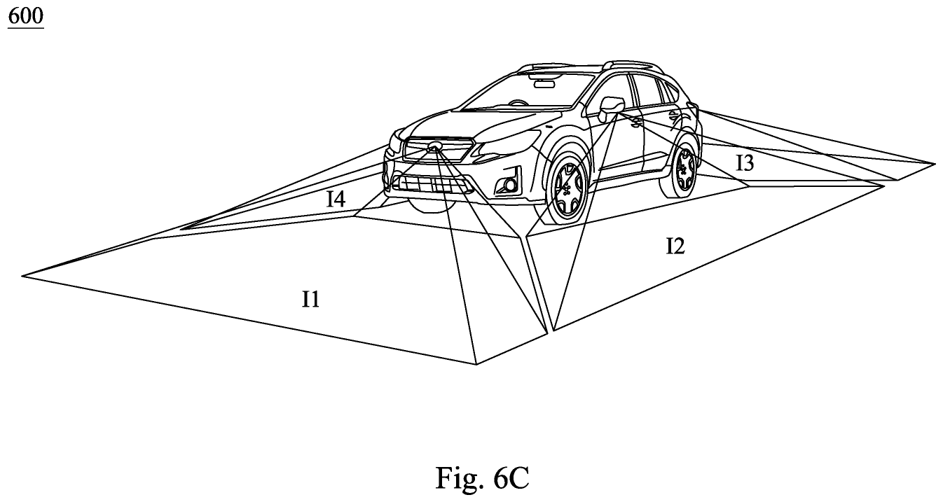

FIG. 6A is a schematic view of a vehicle instrument 600 according to the 6th embodiment of the present disclosure. FIG. 6B is another schematic view of the vehicle instrument 600 according to the 6th embodiment in FIG. 6A. FIG. 6C is another schematic view of the vehicle instrument 600 according to the 6th embodiment in FIG. 6A. In FIGS. 6A to 6C, the vehicle instrument 600 includes a plurality of camera modules 601 and a plurality of image sensors, wherein each of the image sensors is disposed on the image surface of each of the camera modules 601. According to the 6th embodiment, a number of the camera modules 601 is six, and the camera modules 601 includes the imaging lens assembly module according to any example according to the aforementioned 1st to 3rd embodiments, but will not be limited thereto.

In FIGS. 6A and 6B, the camera modules 601 are automotive camera modules, two of the camera modules 601 are located under rearview mirrors on a left side and a right side, respectively, and the aforementioned camera modules 601 are configured to capture the image information of a visual angle A. In particular, the visual angle A can satisfy the following condition: 40 degrees<A<90 degrees. Therefore, the image information in the regions of two lanes on the left side and the right side can be captured.

In FIG. 6B, another two of the camera modules 601 can be disposed in the inner space of the vehicle instrument 600. Specifically, the aforementioned two camera modules 601 are disposed on a location close to the rearview mirror inside the vehicle instrument 600 and a location close to the rear car window, respectively. Moreover, the camera modules 601 can be further disposed on the rearview mirrors of the vehicle instrument 600 on the left side and the right side except the mirror surface, respectively, but the present disclosure is not limited thereto.

In FIG. 6C, another two of the camera modules 601 can be disposed on a front end of the vehicle instrument 600 and a rear end of the vehicle instrument 600, respectively. By disposing the camera modules 601 on the front end and the rear end of the vehicle instrument 600 and under the rearview mirror on the left side of the vehicle instrument 600 and the right side of the vehicle instrument 30, it is favorable for the drivers obtaining the external space information in addition to the driving seat, such as the external space informations I1, I2, I3, I4, but the present disclosure is not limited thereto. Therefore, more visual angles can be provided to reduce the blind spot, so that the driving safety can be improved. Further, the traffic information outside of the vehicle instrument 600 can be recognized by disposing the camera modules 601 on the periphery of the vehicle instrument 600, so that the function of the automatic driving assistance can be achieved.

The foregoing description, for purpose of explanation, has been described with reference to specific examples. It is to be noted that Tables show different data of the different examples; however, the data of the different examples are obtained from experiments. The examples were chosen and described in order to best explain the principles of the disclosure and its practical applications, to thereby enable others skilled in the art to best utilize the disclosure and various examples with various modifications as are suited to the particular use contemplated. The examples depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens assembly module, comprising:
a lens assembly having a central axis; and
an opaque optical element disposed along the central axis with the lens assembly, and comprising:
a central opening disposed around the central axis;
a light blocking portion extending from the central opening to a direction away from the central axis, and facing towards an object side or an image side of the lens assembly; and
a plurality of spiral structures disposed on the light blocking portion, and arranged around the central axis;
wherein each of the spiral structures comprises an adaxial end close to the central axis and an abaxial end away from the central axis, and each of the spiral structures extends spirally from the adaxial end to the abaxial end by surrounding the central axis towards a direction away from the central axis.

2. The imaging lens assembly module of claim 1, wherein the light blocking portion of the opaque optical element faces away from the lens assembly.

3. The imaging lens assembly module of claim 1, wherein the spiral structures protrude from or recess into the light blocking portion.

4. The imaging lens assembly module of claim 1, wherein the spiral structures and the opaque optical element are formed integrally.

5. The imaging lens assembly module of claim 1, wherein each of the spiral structures has at least two curved surfaces.

6. The imaging lens assembly module of claim 1, wherein the central opening is formed by the spiral structures.

7. The imaging lens assembly module of claim 1, wherein the spiral structures surround the central axis and are arranged regularly.

8. The imaging lens assembly module of claim 1, wherein an adaxial point is a middle point of the adaxial end of each of the spiral structures, an abaxial point is a middle point of the abaxial end; with the central axis serving as a pole of a polar coordinate system, a radius difference between the adaxial point and the abaxial point is r, a difference of a polar angle between the adaxial point and the abaxial point is θ, and the following condition is satisfied:
0.01 mm/°≤r/θ≤0.6 mm/°.

9. The imaging lens assembly module of claim 8, wherein the adaxial point is the middle point of the adaxial end of each of the spiral structures, the abaxial point is the middle point of the abaxial end; with the central axis serving as the pole of the polar coordinate system, the radius difference between the adaxial point and the abaxial point is r, the difference of a polar angle between the adaxial point and the abaxial point is θ, and the following condition is satisfied:
0.015 mm/°≤r/θ≤0.45 mm/°.

10. The imaging lens assembly module of claim 1, wherein a number of the spiral structures is N, and the following condition is satisfied:
3<N<365.

11. The imaging lens assembly module of claim 10, wherein the number of the spiral structures is N, and the following condition is satisfied:
3<N<20.

12. The imaging lens assembly module of claim 1, wherein a surface of each of the spiral structures has a plurality of concave-convex structures, each of the concave-convex structures protrudes from or recesses into each of the spiral structures.

13. The imaging lens assembly module of claim 12, wherein the concave-convex structures are micrometer structures and are arranged regularly.

14. The imaging lens assembly module of claim 1, wherein a shortest distance between the central opening of the opaque optical element and the central axis is D1, a shortest distance between the spiral structures and the central axis is D2, and the following condition is satisfied:
0.5≤D1/D2≤1.

15. The imaging lens assembly module of claim 14, wherein the shortest distance between the central opening of the opaque optical element and the central axis is D1, the shortest distance between the spiral structures and the central axis is D2, and the following condition is satisfied:
0.65≤D1/D2<1.

16. The imaging lens assembly module of claim 1, wherein the opaque optical element is a lens barrel, which has an internal space for containing the lens assembly.

17. The imaging lens assembly module of claim 1, wherein each of the spiral structures has an outer side surface facing towards the object side or the image side of the lens assembly, the outer side surface is a curved surface; with the central axis serving as a pole of a polar coordinate system, there is a height variation of the outer side surface along a direction around the central axis and away from the central axis.

18. The imaging lens assembly module of claim 8, wherein the adaxial point is the middle point of the adaxial end of each of the spiral structures, the abaxial point is the middle point of the abaxial end; with the central axis serving as the pole of the polar coordinate system, the difference of a polar angle between the adaxial point and the abaxial point is θ, and the following condition is satisfied:
5°<θ<150°.

19. The imaging lens assembly module of claim 18, wherein the adaxial point is the middle point of the adaxial end of each of the spiral structures, the abaxial point is the middle point of the abaxial end; with the central axis serving as the pole of the polar coordinate system, the difference of a polar angle between the adaxial point and the abaxial point is θ, and the following condition is satisfied:
7°≤θ≤126°.

20. The imaging lens assembly module of claim 1, wherein a spiral extending path of each of the spiral structures has no overlap along a direction away from the central axis.

21. The imaging lens assembly module of claim 1, wherein a shortest distance between the spiral structures and the central axis is D2, a longest distance between the spiral structures and the central axis is Dmax, and the following condition is satisfied:
1.2≤D max/D2≤2.9.

22. An imaging lens assembly module, comprising:
a lens assembly having a central axis; and
a lens barrel having an internal space for containing the lens assembly, and disposed along the central axis with the lens assembly, the lens barrel comprising:
a central opening disposed around the central axis;
a light blocking portion extending from the central opening to a direction away from the central axis, and facing towards an object side of the lens assembly; and
a plurality of spiral structures disposed on the light blocking portion, and arranged around the central axis regularly, wherein the spiral structures and the lens barrel are formed integrally;
wherein each of the spiral structures comprises an adaxial end close to the central axis and an abaxial end away from the central axis, and each of the spiral structures extends spirally from the adaxial end to the abaxial end by surrounding the central axis towards a direction away from the central axis.

23. The imaging lens assembly module of claim 22, wherein each of the spiral structures has at least two curved surfaces.

24. The imaging lens assembly module of claim 22, wherein an adaxial point is a middle point of the adaxial end of each of the spiral structures, an abaxial point is a middle point of the abaxial end; with the central axis serving as a pole of a polar coordinate system, a radius difference between the adaxial point and the abaxial point is r, a difference of a polar angle between the adaxial point and the abaxial point is θ, and the following condition is satisfied:
0.01 mm/°≤r/θ≤0.6 mm/°.

25. The imaging lens assembly module of claim 24, wherein the adaxial point is the middle point of the adaxial end of each of the spiral structures, the abaxial point is the middle point of the abaxial end; with the central axis serving as the pole of the polar coordinate system, the difference of a polar angle between the adaxial point and the abaxial point is θ, and the following condition is satisfied:
5°<θ<150°.

26. The imaging lens assembly module of claim 22, wherein a number of the spiral structures is N, and the following condition is satisfied:
3<N<20.

27. The imaging lens assembly module of claim 22, wherein a shortest distance between the spiral structures and the central axis is D2, a longest distance between the spiral structures and the central axis is Dmax, and the following condition is satisfied:
1.7≤D max/D2≤2.7.

28. A camera module, comprising:
the imaging lens assembly module of claim 1.

29. A camera module, comprising:
the imaging lens assembly module of claim 22.

30. An electronic device, comprising:
the camera module of claim 28.

31. An electronic device, comprising:
the camera module of claim 29.
